(19) United States
(12) Patent Application Publication
(10) Pub. No.: US 2026/0281324 A1
(43) Pub. Date: Sep. 17, 2026

(54) METHOD AND APPARATUS FOR VIDEO COMPRESSION USING SKIP MODES

(71) Applicant: HUAWEI TECHNOLOGIES CO., LTD., Shenzhen (CN)

(72) Inventors: Fabian Brand, Erlangen (DE); Jürgen Seiler, Erlangen (DE); Andre Kaup, Erlangen (DE); Johannes Sauer, Munich (DE); Elena Alexandrovna Alshina, Munich (DE)

(73) Assignee: HUAWEI TECHNOLOGIES CO., LTD., Shenzhen (CN)

(21) Appl. No.: 19/680,799

(22) Filed: May 18, 2026

Related U.S. Application Data
(63) Continuation of application No. PCT/EP2023/082226, filed on Nov. 17, 2023.

(51) Int. Cl. H04N 19/105; H04N 19/139; H04N 19/14; H04N 19/176; H04N 19/196; H04N 19/55

(52) U.S. Cl. CPC H04N 19/105; H04N 19/139; H04N 19/14; H04N 19/176; H04N 19/196; H04N 19/55

(57) ABSTRACT

A video compression device is described having one or more processors configured to execute video compression by, for each of a plurality of regions in a state of a video stream, estimating motion between that region in that state and corresponding regions in other states of the video stream. Selecting one or more parts in the state of the video stream as a part to be skipped in dependence on the respective estimated motion for an associated region in the state of the video stream. Encoding the video data of the video stream to form a residual representing the state of the video stream in one or more channels by, in response to a part having been selected to be skipped, omitting data representing that part in at least one of the channels from the residual.

### CROSS-REFERENCE TO RELATED APPLICATIONS

This application is a continuation of International Application No. PCT/EP2023/082226, filed on Nov. 17, 2023, the disclosure of which is hereby incorporated by reference in its entirety.

### FIELD

Embodiments of the present disclosure generally relate to the field of encoding and decoding data based on a neural network architecture, as well as methods and apparatuses for such encoding and decoding images and/or videos from a bitstream using a plurality of processing layers.

### BACKGROUND

Hybrid image and video codecs have been used for decades to compress image and video data. In such codecs, signal is typically encoded block-wisely by predicting a block and by further coding only the difference between the original block and its prediction. In particular, such coding may include transformation, quantization and generating the bitstream, usually including some entropy coding. Typically, the three components of hybrid coding methods-transformation, quantization, and entropy coding—are separately optimized. Modern video compression standards like High-Efficiency Video Coding (HEVC), Versatile Video Coding (VVC) and Essential Video Coding (EVC) also use transformed representation to code residual signal after prediction.

Recently, neural network architectures have been applied to image and/or video coding. In general, these neural network (NN) based approaches can be applied in various different ways to the image and video coding. For example, some end-to-end optimized image or video coding frameworks have been discussed. Moreover, deep learning has been used to determine or optimize some parts of the end-to-end coding framework such as selection or compression of prediction parameters or the like. Besides, some neural network based approached have also been discussed for usage in hybrid image and video coding frameworks, e.g. for implementation as a trained deep learning model for intra or inter prediction in image or video coding.

The end-to-end optimized image or video coding applications discussed above have in common that they produce some feature map data, which is to be conveyed between encoder and decoder.

Neural networks are machine learning models that employ one or more layers of nonlinear units based on which they can predict an output for a received input. Some neural networks include one or more hidden layers in addition to an output layer. A corresponding feature map may be provided as an output of each hidden layer. Such corresponding feature map of each hidden layer may be used as an input to a subsequent layer in the network, i.e., a subsequent hidden layer or the output layer. Each layer of the network generates an output from a received input in accordance with current values of a respective set of parameters. In a neural network that is split between devices, e.g. between encoder and decoder, a device and a cloud or between different devices, a feature map at the output of the place of splitting (e.g. a first device) is compressed and transmitted to the remaining layers of the neural network (e.g. to a second device).

### SUMMARY

Further improvement of encoding and decoding using trained network architectures may be desirable.

In particular, skip modes are a common technique in both traditional and neural-network-based image and video compression. Skip modes refer to a technique to not transmit certain information in the residual because the gain from transmitting this information does not justify the transmission cost. This is particularly useful when not an image but a residual after prediction is transmitted. If the prediction is good enough, no residual has to be transmitted, and hence the transmission can be skipped.

Theoretically, the encoder can decide for each individual symbol which is transmitted whether or not the quality gain by transmission is worth the rate. However, it is infeasible to transmit this information, since the transmission of a single symbol often costs less than 1 bit. Thus, it is desirable to transmit a skip for a group of symbols.

Skip modes are more efficient in areas where the prediction quality is good. In this case, less information has to be transmitted. It is therefore desirable to transmit different skip parameters in areas where the prediction is of high quality. However, it is generally not possible for the decoder to know where in the image the prediction quality is good, since this requires a ground truth, which is not available at the decoder.

The present disclosure provides methods and apparatuses to improve video compression using skip modes to reduce the transmission cost.

According to a first aspect, the present disclosure provides an apparatus for encoding, where a video compression device having one or more processors is configured to execute video compression by: receiving video data representing a video stream; for each of a plurality of regions in a state of the video stream, estimating motion between that region in that state and corresponding regions in other states of the video stream; selecting one or more parts in the state of the video stream as a part to be skipped in dependence on the respective estimated motion for an associated region in the state of the video stream; and encoding the video data to form a residual representing the state of the video stream in one or more channels by, in response to a part having been selected to be skipped, omitting data representing that part in at least one of the channels from the residual.

This may result in a bitrate saving, as parts of the state of the video stream having relatively low motion can be skipped and not transmitted, and may allow for faster subsequent decoding, as the subsequent parsing of the encoded bitstream is reduced.

The foregoing and other embodiments can each optionally include one or more of the following features, alone or in combination.

In an embodiment of the present disclosure, the one or more processors are configured to, for each part in the state of the video stream having an associated region in the state of the video stream, determine a motion complexity measure based on the estimated motion for the associated region and select the one or more of the parts to be skipped in dependence on the respective motion complexity measure. This may result in more freedom for the encoder. The encoder can determine thresholds based on the motion complexity measure. The coder can skip values with parameters less than the threshold. The encoder could change the estimated parameters (for example the mean and variance) of symbols for regions that will be skipped anyway. Those values could be modified with regard to saving more bits. In an embodiment, those values could be modified such that they become larger than the threshold. This can disable skip for a particular part of the residual. This may, for example, be implemented if the encoder finds that skip caused some problem (such as a coding artefact).

In an embodiment of the present disclosure, the motion complexity measure for the respective part is a local motion variance for the respective associated region. The local motion variance may be determined from a relative displacement field for features of the current state relative to the previous state.

In an embodiment of the present disclosure, the local motion variance is determined from a decoded displacement field for respective spatial positions of the state of the video stream. This may allow the motion complexity measure to be determined from the output of a motion decoder.

In an embodiment of the present disclosure, the local motion variance is a channel-wise variance for the respective associated region. This may allow channel-wise variations to be taken into account.

In an embodiment of the present disclosure, the motion complexity measure for the respective part is a motion entropy for the respective associated region. This may further allow the complexity of motion for the part of the state of the video stream to be determined based on characterization of the pattern and intensity of motion in a video sequence as a function of time.

In an embodiment of the present disclosure, the motion complexity measure for the respective part is a channel-weighted motion variance for the respective associated region. This may allow channel-wise variations to be taken into account.

In an embodiment of the present disclosure, the motion complexity measure for the respective part is learned. The motion complexity measure may be learned using a trained machine learning model.

In an embodiment of the present disclosure, the one or more processors are configured to aggregate the motion complexity measure for the respective part over multiple channels. In an embodiment of the present disclosure, the one or more processors are configured to sum the motion complexity measure for the respective part over multiple channels. This may allow variation of the motion complexity measure over the multiple channels to be taken into account. Other aggregation methods are possible.

In an embodiment of the present disclosure, the one or more processors are configured to aggregate the motion complexity measure for the respective part over a spatial dimension. This may allow different dimensions of motion and features to be handled.

In an embodiment of the present disclosure, the one or more processors are configured to classify each part into one of a plurality of classes based on the estimated motion for the respective associated region. This may allow multiple parts to be grouped together in the skip determination, which may be more bitrate efficient.

In an embodiment of the present disclosure, the one or more processors are configured to classify each part into one of the plurality of classes based on the motion complexity measure for the respective part. This may allow the parts to be efficient classified in dependent on the motion within those respective parts.

In an embodiment of the present disclosure, the plurality of classes are defined by splitting the interval

$$[ {min}_{m , n} C [ m , n ] ; {max}_{m , n} C [ m , n ] ]$$

for a respective state into N sub-intervals and wherein the one or more processors are configured to assign each part a class according to the sub-interval in which the corresponding value of C[m, n] falls, where C is the motion complexity measure, m, n is a spatial position in a latent representation of the state of the video stream and N is the number of classes. This may allow each part of the state of the video stream to be assigned a class that can be used to determine whether a part should be skipped or not. Classifying each part of the video stream into one of a plurality of classes may allow spatial groups of an image to be determined that are then skipped or not skipped accordingly. Therefore, symbols of the bitstream can be grouped to transmit a skip mode more efficiently.

In an embodiment of the present disclosure, the one or more processors are configured to split the interval

$$[ {min}_{m , n} C [ m , n ] ; {max}_{m , n} C [ m , n ] ]$$

for a respective state into N non-overlapping sub-intervals of equal size. This may allow the entire range of the motion complexity measure for the parts of the state of the video stream to be covered and split into classes.

In an embodiment of the present disclosure, the one or more processors are configured to split the interval

$$[ {min}_{m , n} C [ m , n ] ; {max}_{m , n} C [ m , n ] ]$$

for a respective state into N sub-intervals of unequal size. This may allow the distribution of the motion complexity measure to be taken into account.

In an embodiment of the present disclosure, the one or more processors are configured to assign each part a class based on fixed and/or predetermined ranges of the motion complexity measure. Having fixed and/or predetermined ranges may reduce the complexity of the process (for example, the ranges for each class may be predetermined and so do not need to be determined as part of the method).

In an embodiment of the present disclosure, the one or more processors are configured to select one or more of the parts as a part to be skipped in each class separately. This may allow higher granularity and larger flexibility in skip mode selection.

In an embodiment of the present disclosure, the one or more processors are configured to signal for each of the classes skip information to indicate which regions are selected to be skipped. This may allow the approach to be used in combination with established skip modes, and allow such methods to be more easily adaptive with embodiments of the present disclosure.

In an embodiment of the present disclosure, the one or more processors are configured to signal the channels to be skipped for each class. The channels to be skipped may be signalled to the encoder and/or the decoder. This may allow the encoder to only encode data that is signalled not to be skipped and to omit data that is signalled to be skipped from the bitstream.

In an embodiment of the present disclosure, the one or more processors are configured to select one or more of the parts as a part to be skipped by selecting all parts in a class of the plurality of classes to be skipped. Skipping all parts in a class may be more bitrate efficient and may not significantly affect image quality where is it determined that the skipped parts have a relatively low motion complexity.

In an embodiment of the present disclosure, the one or more processors are configured to skip one or more parts in a respective class in dependence on a threshold for that class and the respective motion complexity measure(s) for the respective one or more parts. This may allow only elements which do not carry much information to be skipped. The threshold can set a required amount of information adaptively for each class.

In an embodiment of the present disclosure, each of the plurality of regions in a state of the video stream comprises an associated part of the state of the video stream and multiple neighbouring parts of the state of the video stream. This may allow motion in neighbouring areas of the state of the video stream to be taken into account when determining the complexity of motion within a respective part.

In an embodiment of the present disclosure, the multiple neighbouring parts are multiple pixels adjacent to the associated part. This may allow a motion complexity measure for a pixel to be determined based on the estimated motion of a block comprising the pixel. In some examples, the pixel may be a centre of the block.

In an embodiment of the present disclosure, the device is configured to process the video data using an encoder and a decoder, wherein the decoder is configured to derive the spatial positions of the skipped parts of the state of the video stream. This may allow the coder to more efficiently decode the bitstream received from the encoder.

In an embodiment of the present disclosure, the parts are respective spatial positions in the state of the video stream in a latent space. In other examples, the parts may be respective spatial positions in the feature space or image space.

In an embodiment of the present disclosure, each part corresponds to a pixel of the state of the video stream. This may allow skip modes to be determined at the pixel level.

In an embodiment of the present disclosure, the one or more processors are configured to estimate motion for each of the plurality of regions in dependence on features extracted from the state of the video stream. Extracting features from the state of the video stream and determining differences in the spatial positions of such features for other states of the video stream (for example, adjacent frames) may allow the one or more processors to estimate motion for each of the plurality of regions of the state of the video stream. This may allow a motion complexity measure to be assigned to parts of the state of the video stream being associated with the regions.

In an embodiment of the present disclosure, the one or more processors are configured to estimate motion for each of the plurality of regions in dependence on motion vectors determined between features of different states of the video stream. The different states may be adjacent states (for example adjacent frames) of the video stream. This may be an efficient way of estimating motion in the regions.

In an embodiment of the present disclosure, the one or more processors are configured to generate a skip mask for the state of the video stream, the skip mask indicating which parts of the state are to be skipped. The mask may give skip data for each value of the latent space (across both spatial and the channel dimension) to indicate whether it is to be skipped or not.

In an embodiment of the present disclosure, the state of the video stream is a respective frame of the video stream. In an embodiment of the present disclosure, the corresponding regions in other states of the video stream are corresponding spatial regions in frames of the video stream adjacent to the respective frame. This may allow for encoding of a video sequence.

The encoding apparatus may include a processor and a memory. The processor may be implemented as dedicated hardware. In an embodiment of the present disclosure, the processor may be implemented as a computer program running on a programmable device such as a central processing unit (CPU). The respective memory is arranged to communicate with the respective processor. Memory may be a non-volatile memory. Each device may comprise more than one processor and more than one memory. The memory may store data (i.e. the memory is a data carrier) that is executable by the processor. This may allow the device to perform the method according to the second aspect below.

The encoding apparatus provides technical means for implementing an action in the method defined according to the second aspect below. The function may be implemented by hardware, or may be implemented by hardware executing corresponding software. Modules of the encoding apparatus may be adapted to provide respective functions which correspond to the method example according to the second aspect.

According to a second aspect, the present disclosure relates to a method for encoding. The method is performed by the apparatus above. In an embodiment of the present disclosure, the method comprises a video compression method comprising: receiving video data representing a video stream; for each of a plurality of regions in a state of the video stream, estimating motion between that region in that state and corresponding regions in other states of the video stream; selecting one or more parts of the state of the video stream as a part to be skipped in dependence on the respective estimated motion for an associated region of the state of the video stream; and encoding the video data to form a residual representing the state of the video stream in one or more channels by, in response to a part having been selected to be skipped, omitting data representing that part in at least one of the channels from the residual.

This method may result in a bitrate saving, as parts of the state of the video stream having relatively low motion can be skipped and not transmitted, and may allow for faster subsequent decoding, as the subsequent parsing of the encoded bitstream is reduced.

The method may have any of the features defined above for the first aspect.

According to a third aspect, the present disclosure relates to an apparatus for decoding. In an embodiment of the present disclosure, the apparatus comprises a video compression device having one or more processors configured to execute video decompression by: receiving encoded data for one or more first parts of a state of a video stream and skip data indicating an absence of encoded data for one or more second parts of the state of the video stream; decoding the received encoded data to reconstruct a representation of the state of the video stream in one or more channels for the one or more first parts of the state of the video stream, the one or more first parts being associated with respective regions of the state of the video stream that have the greatest motion relative to corresponding regions in other states of the video stream; and reconstructing a representation of the state of the video stream in one or more channels for the one or more second parts of the video stream.

This may allow for faster decoding of a bitstream, as the parsing of the encoded bitstream is reduced.

In an embodiment of the present disclosure, each first part and each second part in the state of the video stream has an associated region in the state of the video stream, wherein motion of a region relative to corresponding regions in other states of the video stream is indicated by a motion complexity measure. This may allow motion to be estimated in a quantifiable way that can be used to classify different spatial parts of the state of the video stream and to determine which parts can be skipped.

It may be determined that the region(s) associated with the one or more first parts have the greatest motion (between that region in that state and corresponding regions in other states of the video stream) of the parts of the state compared to other parts of the state by determining the motion complexity measure for each part of the state of the video stream. The one or more first parts may have a higher motion complexity measure than the one or more second parts. The one or more second parts may have a lower motion complexity measure than the one or more first parts. In other words, parts having the greatest motion are parts having the greatest motion complexity measure.

The decoding apparatus may include a processor and a memory. The processor may be implemented as dedicated hardware. In an embodiment of the present disclosure, the processor may be implemented as a computer program running on a programmable device such as a central processing unit (CPU). The respective memory is arranged to communicate with the respective processor. Memory may be a non-volatile memory. Each device may comprise more than one processor and more than one memory. The memory may store data (i.e. the memory is a data carrier) that is executable by the processor. This may allow the device to perform the method according to the fourth aspect below.

Such apparatus for decoding may refer to the same advantageous effect as the method for decoding according to the fourth aspect below. The decoding apparatus provides technical means for implementing an action in the method defined according to the fourth aspect. The function may be implemented by hardware, or may be implemented by hardware executing corresponding software.

The apparatus may have any of the additional features defined above for the first aspect.

According to a fourth aspect, the present disclosure relates to a method for decoding. In an embodiment of the present disclosure, the method comprises a video decompression method comprising: receiving encoded data for one or more first parts of a state of a video stream and skip data indicating an absence of encoded data for one or more second parts of the state of the video stream; decoding the received encoded data to reconstruct a representation of the state of the video stream in one or more channels for the one or more first parts of the state of the video stream, the one or more first parts being associated with respective regions of the state of the video stream that have the greatest motion relative to corresponding regions in other states of the video stream; and reconstructing a representation of the state of the video stream in one or more channels for the one or more second parts of the video stream.

Such a method for decoding may refer to the same advantageous effect as the apparatus for decoding according to the third aspect.

The method according to the second aspect of the present disclosure may be performed by the apparatus according to the first aspect of the present disclosure. Further features and implementations of the method according to the second aspect of the present disclosure correspond to respective features and implementations of the apparatus according to the first aspect of the present disclosure. The advantages of the method according to the second aspect can be the same as those for the corresponding implementation of the apparatus according to the first aspect.

The method according to the fourth aspect of the present disclosure may be performed by the apparatus according to the third aspect of the present disclosure. Further features and implementations of the method according to the fourth aspect of the present disclosure correspond to respective features and implementations of the apparatus according to the third aspect of the present disclosure. The advantages of the method according to the fourth aspect can be the same as those for the corresponding implementation of the apparatus according to the second aspect.

According to a fifth aspect, the present disclosure relates to a bitstream representing a state of a video stream, the bitstream comprising blocks of data, each block of data being decodable to reconstruct a representation of a respective first part of the state of the video stream, and the bitstream comprising skip data indicating an absence from the bitstream of such a block of data for one or more second parts of the state of the video stream, wherein the one or more first parts are associated with regions of the state of the video stream that have the greatest motion relative to corresponding regions in other states of the video stream.

This may allow for faster decoding of a bitstream, as the parsing of the encoded bitstream is reduced. The bitstream may be non-transient. The bitstream may be stored on a data carrier.

In an embodiment of the present disclosure, each first part and each second part in the state of the video stream has an associated region in the state of the video stream, wherein motion of a region relative to corresponding regions in other states of the video stream is indicated by a motion complexity measure.

A further embodiment of the present disclosure may provide a system for delivering a bitstream, including: at least one storage medium, configured to store at least one bitstream as defined above or as generated by the encoding method described above; a video streaming device, configured to obtain a bitstream from one of the at least one storage medium, and send the bitstream to a terminal device; where the video streaming device includes a content server or a content delivery server.

In an embodiment of the present disclosure, the system may further include: one or more processor, configured to perform encryption processing on at least one bitstream to obtain at least one encrypted bitstream; the at least one storage medium, configured to store the encrypted bitstream; or, the one or more processor, configured to converting a bitstream in a first format into a bitstream in a second format; the at least one storage medium, configured to store the bitstream in the second format. In an embodiment of the present disclosure, further including: a receiver, configured to receive a first operation request; and; the one or more processor, configured to determine a target bitstream in the at least one storage medium in response to the first operation request; a transmitter, configured to send the target bitstream to a terminal-side apparatus. In an embodiment of the present disclosure, the one or more processor is further configured to: encapsulate a bitstream to obtain a transport stream in a first format; and the transmitter, is further configured to: send the transport stream in the first format to a terminal-side apparatus for display; or, send the transport stream in the first format to storage space for storage.

In an embodiment of the present disclosure, an exemplary method for storing a bitstream is provided, the method includes: obtaining a bitstream according to any one of the encoding methods illustrated before; storing the bitstream in a storage medium. In an embodiment of the present disclosure, the method further includes: performing encryption processing on the bitstream to obtain an encrypted bitstream; and; storing the encrypted bitstream in the storage medium. It should be understood that any of the known encryption methods may be employed.

In an embodiment of the present disclosure, an exemplary system for storing a bitstream is provided, the system, including: a receiver, configured to receive a bitstream generated by any one of the before encoding methods; and; a processor, configured to perform encryption processing on the bitstream to obtain an encrypted bitstream; and; a computer readable storage medium, configured to store the encrypted bitstream.

In an embodiment of the present disclosure, the system includes a video streaming device, where the video streaming device can be a content server or a content delivery server, where the video streaming device is configured to obtain a bitstream from the storage medium, and send the bitstream to a terminal device.

According to a sixth aspect, the present disclosure relates to a method of video compression for a video stream, the method comprising: receiving a bitstream as above; and decoding the bitstream to form a representation of the state of the video stream in one or more channels.

According to a seventh aspect, the present disclosure relates to a video stream decoding apparatus, including a processor and a memory. The memory stores instructions that cause the processor to perform the method according to the fourth aspect.

According to an eighth aspect, the present disclosure relates to a video stream encoding apparatus, including a processor and a memory. The memory stores instructions that cause the processor to perform the method according to the second aspect.

According to a ninth aspect, a computer-readable storage medium having stored thereon instructions that when executed cause one or more processors to encode video data is proposed. The instructions cause the one or more processors to perform the method according to the second or fourth aspect or any possible embodiment of the second or fourth aspect.

According to a tenth aspect, the present disclosure relates to a computer program product including program code for performing the method according to the second or fourth aspect or any possible embodiment of the second or fourth aspect when executed on a computer.

According to an eleventh aspect, there is provided a computer program stored on a non-transitory medium and including code instructions, which, when executed on one or more processor, causes the one or more processor to execute the method according to any possible embodiment of the second aspect or the fourth aspect.

According to a twelfth aspect, there is provided a system for delivering video data, the system comprising at least one storage medium configured to store video data generated by the methods above.

Details of one or more embodiments are set forth in the accompanying drawings and the description below. Other features, objects, and advantages will be apparent from the description, drawings, and claims.

### BRIEF DESCRIPTION OF THE DRAWINGS

In the following embodiments of the present disclosure are described in more detail with reference to the attached figures and drawings, in which:

FIG. 1 is a schematic drawing illustrating channels processed by layers of a neural network;

FIG. 2 is a schematic drawing illustrating an autoencoder type of a neural network;

FIG. 3A is a schematic drawing illustrating an exemplary network architecture for encoder and decoder side including a hyperprior model;

FIG. 3B is a schematic drawing illustrating a general network architecture for encoder side including a hyperprior model;

FIG. 3C is a schematic drawing illustrating a general network architecture for decoder side including a hyperprior model;

FIG. 4 is a schematic drawing illustrating an exemplary network architecture for encoder and decoder side including a hyperprior model;

FIG. 5 is a block diagram illustrating a structure of a cloud-based solution for machine based tasks such as machine vision tasks;

FIG. 6A is a block diagram illustrating end-to-end video compression framework based on a neural networks;

FIG. 6B is a block diagram illustrating some exemplary details of application of a neural network for motion field compression;

FIG. 6C is a block diagram illustrating some exemplary details of application of a neural network for motion compensation;

FIG. 7 shows a device for decoding for processing by a neural network based unit;

FIG. 8 shows a device for encoding for processing by a neural network based unit;

FIG. 9 is a diagram illustrating an exemplary coder;

FIG. 10 is a diagram illustrating further details of an exemplary coder;

FIG. 11 is a diagram illustrating an example of the computation of a motion complexity measure for a single 8×8 block;

FIG. 12 is a flow diagram illustrating an exemplary method for encoding in accordance with embodiments of a video compression method described herein;

FIG. 13 is a flow diagram illustrating an exemplary method for decoding in accordance with embodiments of a video decompression method described herein;

FIG. 14 is a block diagram illustrating an example of an encoding apparatus;

FIG. 15 is a block diagram illustrating another example of a decoding apparatus;

FIG. 16 shows a bitstream structure;

FIG. 17 is a block diagram showing an example of a video coding system configured to implement embodiments of the present disclosure;

FIG. 18 is a block diagram showing another example of a video coding system configured to implement embodiments of the present disclosure;

FIG. 19 is a block diagram illustrating an example of an encoding apparatus or a decoding apparatus;

FIG. 20 is a block diagram illustrating another example of an encoding apparatus or a decoding apparatus.

FIG. 21 is a block diagram illustrating another example of an encoding apparatus or a decoding apparatus.

Like reference numbers and designations in different drawings may indicate similar elements.

### DETAILED DESCRIPTION

In the following description, reference is made to the accompanying figures, which form part of the present disclosure, and which show, by way of illustration, specific aspects of embodiments of the present disclosure or specific aspects in which embodiments of the present disclosure may be used. It is understood that embodiments of the present disclosure may be used in other aspects and comprise structural or logical changes not depicted in the figures. The following detailed description, therefore, is not to be taken in a limiting sense.

For instance, it is understood that a disclosure in connection with a described method may also hold true for a corresponding device or system configured to perform the method and vice versa. For example, if one or a plurality of specific method steps are described, a corresponding device may include one or a plurality of units, e.g. functional units, to perform the described one or plurality of method steps (e.g. one unit performing the one or plurality of steps, or a plurality of units each performing one or more of the plurality of steps), even if such one or more units are not explicitly described or illustrated in the figures. On the other hand, for example, if a specific apparatus is described based on one or a plurality of units, e.g. functional units, a corresponding method may include one step to perform the functionality of the one or plurality of units (e.g. one step performing the functionality of the one or plurality of units, or a plurality of steps each performing the functionality of one or more of the plurality of units), even if such one or plurality of steps are not explicitly described or illustrated in the figures. Further, it is understood that the features of the various exemplary embodiments and/or aspects described herein may be combined with each other, unless specifically noted otherwise.

In the following, an overview over some of the used technical terms and framework within which the embodiments of the present disclosure may be employed is provided.

### Artificial Neural Networks

Artificial neural networks (ANN) or connectionist systems are computing systems vaguely inspired by the biological neural networks that constitute animal brains. Such systems “learn” to perform tasks by considering examples, generally without being programmed with task-specific rules. For example, in image recognition, they might learn to identify images that contain cats by analyzing example images that have been manually labeled as “cat” or “no cat” and using the results to identify cats in other images. They do this without any prior knowledge of cats, for example, that they have fur, tails, whiskers and cat-like faces. Instead, they automatically generate identifying characteristics from the examples that they process.

An ANN is based on a collection of connected units or nodes called artificial neurons, which loosely model the neurons in a biological brain. Each connection, like the synapses in a biological brain, can transmit a signal to other neurons. An artificial neuron that receives a signal then processes it and can signal neurons connected to it.

In ANN implementations, the “signal” at a connection is a real number, and the output of each neuron is computed by some non-linear function of the sum of its inputs. The connections are called edges. Neurons and edges typically have a weight that adjusts as learning proceeds. The weight increases or decreases the strength of the signal at a connection. Neurons may have a threshold such that a signal is sent only if the aggregate signal crosses that threshold. Typically, neurons are aggregated into layers. Different layers may perform different transformations on their inputs. Signals travel from the first layer (the input layer), to the last layer (the output layer), possibly after traversing the layers multiple times.

The original goal of the ANN approach was to solve problems in the same way that a human brain would. Over time, attention moved to performing specific tasks, leading to deviations from biology. ANNs have been used on a variety of tasks, including computer vision, speech recognition, machine translation, social network filtering, playing board and video games, medical diagnosis, and even in activities that have traditionally been considered as reserved to humans, like painting.

The name “convolutional neural network” (CNN) indicates that the network employs a mathematical operation called convolution. Convolution is a specialized kind of linear operation. Convolutional networks are neural networks that use convolution in place of a general matrix multiplication in at least one of their layers.

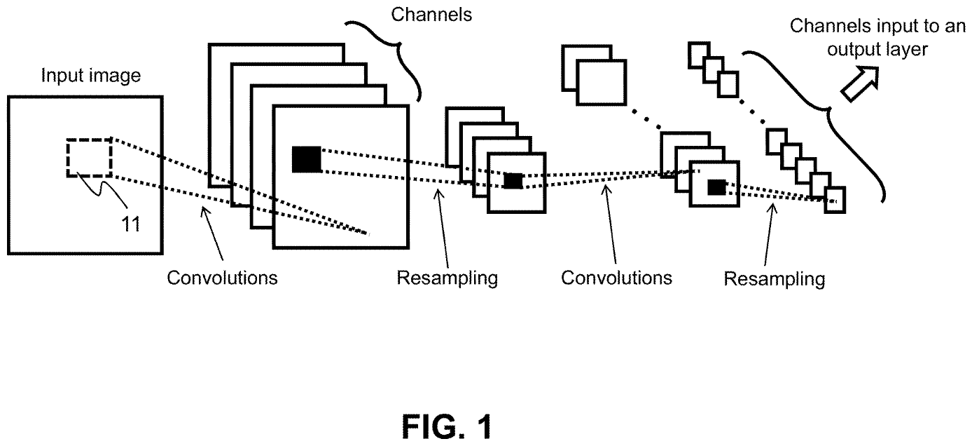

FIG. 1 schematically illustrates a general concept of processing by a neural network such as the CNN. A convolutional neural network consists of an input and an output layer, as well as multiple hidden layers. Input layer is the layer to which the input (such as a portion 11 of an input image as shown in FIG. 1) is provided for processing. The hidden layers of a CNN typically consist of a series of convolutional layers that convolve with a multiplication or other dot product. The result of a layer is one or more feature maps (illustrated by empty solid-line rectangles), sometimes also referred to as channels. There may be a resampling (such as subsampling) involved in some or all of the layers. As a consequence, the feature maps may become smaller, as illustrated in FIG. 1. It is noted that a convolution with a stride may also reduce the size (resample) an input feature map. The activation function in a CNN is usually a ReLU (Rectified Linear Unit) layer or Leaky ReLU, and is subsequently followed by additional convolutions such as pooling layers, fully connected layers and normalization layers, referred to as hidden layers because their inputs and outputs are masked by the activation function and final convolution. Though the layers are colloquially referred to as convolutions, this is only by convention. Mathematically, it is technically a sliding dot product or cross-correlation. This has significance for the indices in the matrix, in that it affects how the weight is determined at a specific index point.

When programming a CNN for processing images, as shown in FIG. 1, the input is a tensor with shape (number of images)×(image width)×(image height)×(image depth). It should be known that the image depth can be constituted by channels of an image. After passing through a convolutional layer, the image becomes abstracted to a feature map, with shape (number of images)×(feature map width)×(feature map height)×(feature map channels). A convolutional layer within a neural network should have the following attributes. Convolutional kernels defined by a width and height (hyper-parameters). The number of input channels and output channels (hyper-parameter). The depth of the convolution filter (the input channels) should be equal to the number channels (depth) of the input feature map.

In the past, traditional multilayer perceptron (MLP) models have been used for image recognition. However, due to the full connectivity between nodes, they suffered from high dimensionality, and did not scale well with higher resolution images. A 1000×1000-pixel image with RGB color channels has 3 million weights, which is too high to feasibly process efficiently at scale with full connectivity. Also, such network architecture does not take into account the spatial structure of data, treating input pixels which are far apart in the same way as pixels that are close together. This ignores locality of reference in image data, both computationally and semantically. Thus, full connectivity of neurons is wasteful for purposes such as image recognition that are dominated by spatially local input patterns.

Convolutional neural networks are biologically inspired variants of multilayer perceptrons that are specifically designed to emulate the behavior of a visual cortex. These models mitigate the challenges posed by the MLP architecture by exploiting the strong spatially local correlation present in natural images. The convolutional layer is the core building block of a CNN. The layer's parameters consist of a set of learnable filters (the above-mentioned kernels), which have a small receptive field, but extend through the full depth of the input volume. During the forward pass, each filter is convolved across the width and height of the input volume, computing the dot product between the entries of the filter and the input and producing a 2-dimensional activation map of that filter. As a result, the network learns filters that activate when it detects some specific type of feature at some spatial position in the input.

Stacking the activation maps for all filters along the depth dimension forms the full output volume of the convolution layer. Every entry in the output volume can thus also be interpreted as an output of a neuron that looks at a small region in the input and shares parameters with neurons in the same activation map. A feature map, or activation map, is the output activations for a given filter. Feature map and activation have the same meaning. In some papers it is called an activation map because it is a mapping that corresponds to the activation of different parts of the image, and also a feature map because it is also a mapping of where a certain kind of feature is found in the image. A high activation means that a certain feature was found.

Another important concept of CNNs is pooling, which is a form of non-linear downsampling. There are several non-linear functions to implement pooling among which max pooling is the most common. It partitions the input image into a set of non-overlapping rectangles and, for each such sub-region, outputs the maximum.

Intuitively, the exact location of a feature is less important than its rough location relative to other features. This is the idea behind the use of pooling in convolutional neural networks. The pooling layer serves to progressively reduce the spatial size of the representation, to reduce the number of parameters, memory footprint and amount of computation in the network, and hence to also control overfitting. It is common to periodically insert a pooling layer between successive convolutional layers in a CNN architecture. The pooling operation provides another form of translation invariance.

The pooling layer operates independently on every depth slice of the input and resizes it spatially. The most common form is a pooling layer with filters of size 2×2 applied with a stride of 2 at every depth slice in the input by 2 along both width and height, discarding 75% of the activations. In this case, every max operation is over 4 numbers. The depth dimension remains unchanged. In addition to max pooling, pooling units can use other functions, such as average pooling or l2-norm pooling. Average pooling was often used historically but has recently fallen out of favour compared to max pooling, which often performs better in practice. Due to the aggressive reduction in the size of the representation, there is a recent trend towards using smaller filters or discarding pooling layers altogether. “Region of Interest” pooling (also known as ROI pooling) is a variant of max pooling, in which output size is fixed and input rectangle is a parameter. Pooling is an important component of convolutional neural networks for object detection based on Fast R-CNN architecture.

The above-mentioned ReLU is the abbreviation of rectified linear unit, which applies the non-saturating activation function. It effectively removes negative values from an activation map by setting them to zero. It increases the nonlinear properties of the decision function and of the overall network without affecting the receptive fields of the convolution layer. Other functions are also used to increase nonlinearity, for example the saturating hyperbolic tangent and the sigmoid function. ReLU is often preferred to other functions because it trains the neural network several times faster without a significant penalty to generalization accuracy.

A Leaky Rectified Linear Unit, or Leaky ReLU, is a type of activation function based on a ReLU, but it has a small slope for negative values instead of a flat slope. The slope coefficient is determined before training, i.e. it is not learnt during training. This type of activation function is popular in tasks where it suffers from sparse gradients, for example training generative adversarial networks. Leaky ReLU applies the element-wise function:

$$LeakyReLU ( x ) = max ( 0 , x ) + negative\_slope * min ( 0 , x ) , or$$

$$LeakyReLU ( x ) = \{ \begin{matrix}x , if x \geq 0 \\ negative\_slope * x , otherwise\end{matrix}$$

Among them, parameters:
negative_slope—Controls the angle of the negative slope. Default: 1e-2
inplace—can optionally do the operation in-place. Default: False.

After several convolutional and max pooling layers, the high-level reasoning in the neural network is done via fully connected layers. Neurons in a fully connected layer have connections to all activations in the previous layer, as seen in regular (non-convolutional) artificial neural networks. Their activations can thus be computed as an affine transformation, with matrix multiplication followed by a bias offset (vector addition of a learned or fixed bias term).

The “loss layer” (including calculating of a loss function) specifies how training penalizes the deviation between the predicted (output) and true labels and is normally the final layer of a neural network. Various loss functions appropriate for different tasks may be used. Softmax loss is used for predicting a single class of K mutually exclusive classes. Sigmoid cross-entropy loss is used for predicting K independent probability values in [0, 1]. Euclidean loss is used for regressing to real-valued labels.

In summary, FIG. 1 shows the data flow in a typical convolutional neural network. First, the input image is passed through convolutional layers and becomes abstracted to a feature map comprising several channels, corresponding to a number of filters in a set of learnable filters of this layer. Then, the feature map is subsampled using e.g. a pooling layer, which reduces the dimension of each channel in the feature map. Next, the data comes to another convolutional layer, which may have different numbers of output channels. As was mentioned above, the number of input channels and output channels are hyper-parameters of the layer. To establish connectivity of the network, those parameters need to be synchronized between two connected layers, such that the number of input channels for the current layers should be equal to the number of output channels of the previous layer. For the first layer which processes input data, e.g. an image, the number of input channels is normally equal to the number of channels of data representation, for instance 3 channels for RGB or YUV representation of images or video, or 1 channel for grayscale image or video representation. The channels obtained by one or more convolutional layers (and possibly resampling layer(s)) may be passed to an output layer. Such output layer may be a convolutional or resampling in some implementations. In an exemplary and non-limiting implementation, the output layer is a fully connected layer.

### Autoencoders and Unsupervised Learning

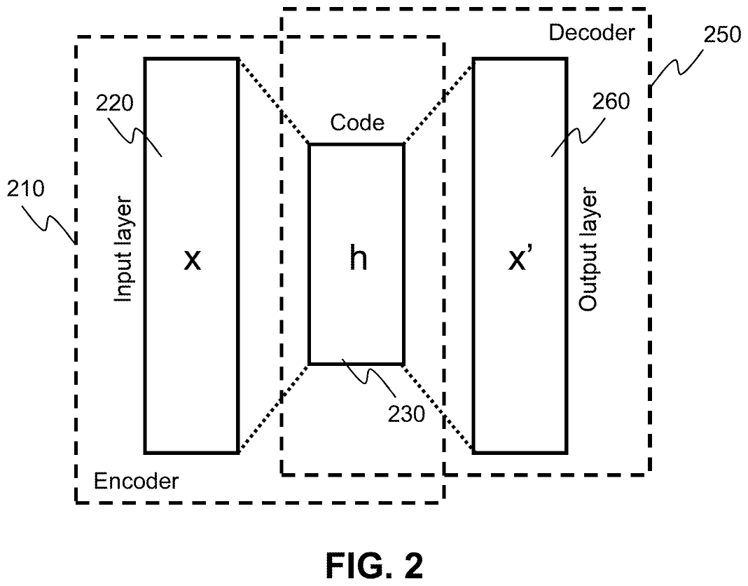

An autoencoder is a type of artificial neural network used to learn efficient data codings in an unsupervised manner. A schematic drawing thereof is shown in FIG. 2. The autoencoder includes an encoder side 210 with an input x inputted into an input layer of an encoder subnetwork 220 and a decoder side 250 with output x′ outputted from a decoder subnetwork 260. The aim of an autoencoder is to learn a representation (encoding) 230 for a set of data x, typically for dimensionality reduction, by training the network 220, 260 to ignore signal “noise”. Along with the reduction (encoder) side subnetwork 220, a reconstructing (decoder) side subnetwork 260 is learnt, where the autoencoder tries to generate from the reduced encoding 230 a representation x′ as close as possible to its original input x, hence its name. In the simplest case, given one hidden layer, the encoder stage of an autoencoder takes the input x and maps it to h

$$h = σ ( Wx + b ) .$$

This image h is usually referred to as code 230, latent variables, or latent representation. Here, σ is an element-wise activation function such as a sigmoid function or a rectified linear unit. W is a weight matrix b is a bias vector. Weights and biases are usually initialized randomly, and then updated iteratively during training through Backpropagation. After that, the decoder stage of the autoencoder maps h to the reconstruction x′ of the same shape as x:

$${x}^{′} = {σ}^{′} ( {W}^{′} {h}^{′} + {b}^{′} )$$

where σ′, W′ and b′ for the decoder may be unrelated to the corresponding σ, W and b for the encoder.

Variational autoencoder models make strong assumptions concerning the distribution of latent variables. They use a variational approach for latent representation learning, which results in an additional loss component and a specific estimator for the training algorithm called the Stochastic Gradient Variational Bayes (SGVB) estimator. It assumes that the data is generated by a directed graphical model p_{θ}(x|h) and that the encoder is learning an approximation q_{φ}(h|x) to the posterior distribution p_{θ}(h|x) where φ and θ denote the parameters of the encoder (recognition model) and decoder (generative model) respectively. The probability distribution of the latent vector of a VAE typically matches that of the training data much closer than a standard autoencoder. The objective of VAE has the following form:

$$ℒ ( ϕ , θ , x ) = {D}_{KL} ( {q}_{ϕ} ( h \vert x ) ‖ {p}_{θ} ( h ) ) - {E}_{{q}_{ϕ} ( h \vert x )} ( log {p}_{θ} ( x \vert h ) )$$

Here, D_{KL} stands for the Kullback-Leibler divergence. The prior over the latent variables is usually set to be the centered isotropic multivariate Gaussian p_{θ}(h)= [symbol] (0, 1). Commonly, the shape of the variational and the likelihood distributions are chosen such that they are factorized Gaussians:

$${q}_{ϕ} ( h \vert x ) = 𝒩 ( ρ ( x ) , {ω}^{2} ( x ) I )$$

$${p}_{ϕ} ( x \vert h ) = 𝒩 ( μ ( h ) , {σ}^{2} ( h ) I )$$

where ρ(x) and ω²(x) are the encoder output, while μ(h) and σ²(h) are the decoder outputs. Recent progress in artificial neural networks area and especially in convolutional neural networks enables researchers' interest of applying neural networks based technologies to the task of image and video compression. For example, End-to-end Optimized Image Compression has been proposed, which uses a network based on a variational autoencoder.

Accordingly, data compression is considered as a fundamental and well-studied problem in engineering, and is commonly formulated with the goal of designing codes for a given discrete data ensemble with minimal entropy. The solution relies heavily on knowledge of the probabilistic structure of the data, and thus the problem is closely related to probabilistic source modeling. However, since all practical codes must have finite entropy, continuous-valued data (such as vectors of image pixel intensities) must be quantized to a finite set of discrete values, which introduces an error.

In this context, known as the lossy compression problem, one must trade off two competing costs: the entropy of the discretized representation (rate) and the error arising from the quantization (distortion). Different compression applications, such as data storage or transmission over limited-capacity channels, demand different rate-distortion trade-offs.

Joint optimization of rate and distortion is difficult. Without further constraints, the general problem of optimal quantization in high-dimensional spaces is intractable. For this reason, most existing image compression methods operate by linearly transforming the data vector into a suitable continuous-valued representation, quantizing its elements independently, and then encoding the resulting discrete representation using a lossless entropy code. This scheme is called transform coding due to the central role of the transformation.

For example, Joint Photographic Experts Group (JPEG) uses a discrete cosine transform on blocks of pixels, and JPEG 2000 uses a multi-scale orthogonal wavelet decomposition. Typically, the three components of transform coding methods—transform, quantizer, and entropy code—are separately optimized (often through manual parameter adjustment). Modern video compression standards like HEVC, VVC and EVC also use transformed representation to code residual signal after prediction. The several transforms are used for that purpose such as discrete cosine and sine transforms (DCT, DST), as well as low frequency non-separable manually optimized transforms (LFNST).

### Variational Image Compression

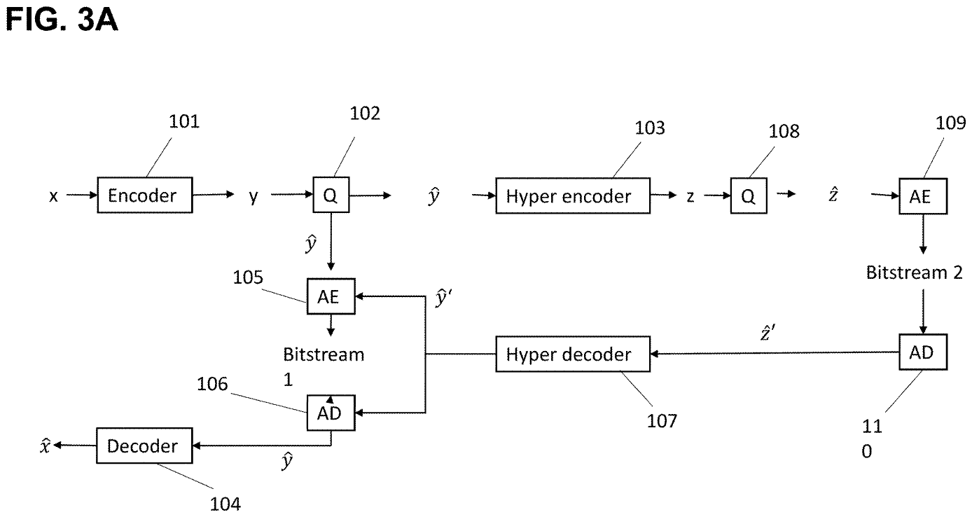

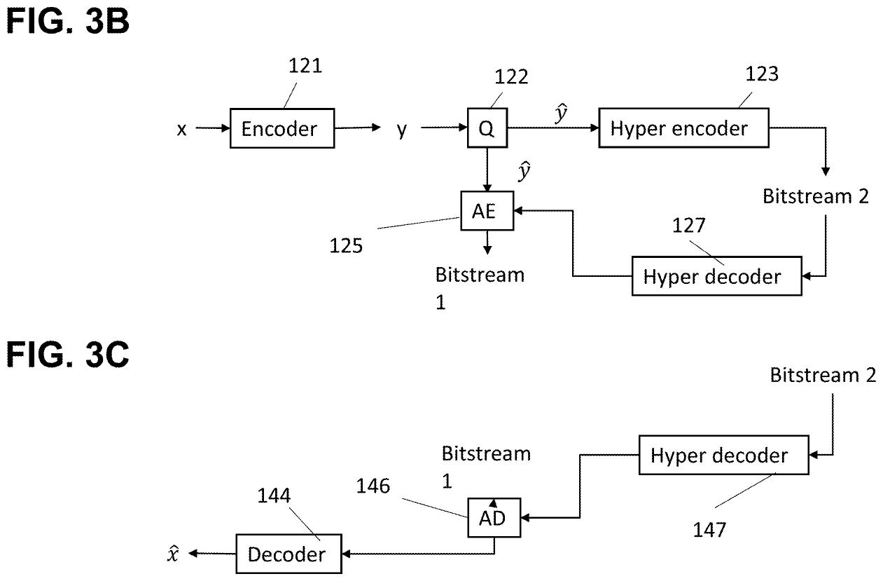

Variable Auto-Encoder (VAE) framework can be considered as a nonlinear transforming coding model. The transforming process can be mainly divided into four parts. This is exemplified in FIG. 3A showing a VAE framework.

The transforming process can be mainly divided into four parts: FIG. 3A exemplifies the VAE framework. In FIG. 3A, the encoder 101 maps an input image x into a latent representation (denoted by y) via the function y=f(x). This latent representation may also be referred to as a part of or a point within a “latent space” in the following. The function f( ) is a transformation function that converts the input signal x into a more compressible representation y. The quantizer 102 transforms the latent representation y into the quantized latent representation ŷ with (discrete) values by ŷ=Q(y), with Q representing the quantizer function. The entropy model, or the hyper encoder/decoder (also known as hyperprior) 103 estimates the distribution of the quantized latent representation ŷ to get the minimum rate achievable with a lossless entropy source coding.

The latent space can be understood as a representation of compressed data in which similar data points are closer together in the latent space. Latent space is useful for learning data features and for finding simpler representations of data for analysis. The quantized latent representation T, ŷ and the side information \hat{z} of the hyperprior 3 are included into a bitstream 2 (are binarized) using arithmetic coding (AE). Furthermore, a decoder 104 is provided that transforms the quantized latent representation to the reconstructed image \hat{x}, \hat{x}=g(ŷ). The signal \hat{x} is the estimation of the input image x. It is desirable that x is as close to \hat{x} as possible, in other words the reconstruction quality is as high as possible. However, the higher the similarity between \hat{x} and x, the higher the amount of side information necessary to be transmitted. The side information includes bitstream 1 and bitstream 2 shown in FIG. 3A, which are generated by the encoder and transmitted to the decoder. Normally, the higher the amount of side information, the higher the reconstruction quality. However, a high amount of side information means that the compression ratio is low. Therefore, one purpose of the system described in FIG. 3A is to balance the reconstruction quality and the amount of side information conveyed in the bitstream.

In FIG. 3A the component AE 105 is the Arithmetic Encoding module, which converts samples of the quantized latent representation y and the side information \hat{z} into a binary representation bitstream 1. The samples of ŷ and \hat{z} might for example comprise integer or floating point numbers. One purpose of the arithmetic encoding module is to convert (via the process of binarization) the sample values into a string of binary digits (which is then included in the bitstream that may comprise further portions corresponding to the encoded image or further side information).

The arithmetic decoding (AD) 106 is the process of reverting the binarization process, where binary digits are converted back to sample values. The arithmetic decoding is provided by the arithmetic decoding module 106.

It is noted that the present disclosure is not limited to this particular framework. Moreover, the present disclosure is not restricted to image or video compression, and can be applied to object detection, image generation, and recognition systems as well.

In FIG. 3A there are two sub networks concatenated to each other. A subnetwork in this context is a logical division between the parts of the total network. For example, in FIG. 3A the modules 101, 102, 104, 105 and 106 are called the “Encoder/Decoder” subnetwork. The “Encoder/Decoder” subnetwork is responsible for encoding (generating) and decoding (parsing) of the first bitstream “bitstream 1.” The second network in FIG. 3A comprises modules 103, 108, 109, 110 and 107 and is called “hyper encoder/decoder” subnetwork. The second subnetwork is responsible for generating the second bitstream “bitstream 2.” The purposes of the two subnetworks are different.

The first subnetwork is responsible for:
the transformation 101 of the input image x into its latent representation y (which is easier to compress that x),
quantizing 102 the latent representation y into a quantized latent representation ŷ,
compressing the quantized latent representation ŷ using the AE by the arithmetic encoding module 105 to obtain bitstream “bitstream 1”,”.
parsing the bitstream 1 via AD using the arithmetic decoding module 106, and
reconstructing 104 the reconstructed image (\hat{x}) using the parsed data.

The purpose of the second subnetwork is to obtain statistical properties (e.g. mean value, variance and correlations between samples of bitstream 1) of the samples of “bitstream 1,” such that the compressing of bitstream 1 by first subnetwork is more efficient. The second subnetwork generates a second bitstream “bitstream 2,” which comprises the said information (e.g. mean value, variance and correlations between samples of bitstream 1).

The second network includes an encoding part which comprises transforming 103 of the quantized latent representation ŷ into side information z, quantizing the side information z into quantized side information \hat{z}, and encoding (e.g. binarizing) 109 the quantized side information \hat{z} into bitstream 2. In this example, the binarization is performed by an arithmetic encoding (AE). A decoding part of the second network includes arithmetic decoding (AD) 110, which transforms the input bitstream 2 into decoded quantized side information \hat{z}′. The \hat{z}′ might be identical to \hat{z}, since the arithmetic encoding end decoding operations are lossless compression methods. The decoded quantized side information \hat{z}′ is then transformed 107 into decoded side information ŷ′. ŷ′ represents the statistical properties of ŷ (e.g. mean value of samples of ŷ, or the variance of sample values or like). The decoded latent representation ŷ′ is then provided to the above-mentioned Arithmetic Encoder 105 and Arithmetic Decoder 106 to control the probability model of ŷ.

The FIG. 3A describes an example of VAE (variational auto encoder), details of which might be different in different implementations. For example in a specific implementation additional components might be present to more efficiently obtain the statistical properties of the samples of bitstream 1. In one such implementation a context modeler might be present, which targets extracting cross-correlation information of the bitstream 1. The statistical information provided by the second subnetwork might be used by AE (arithmetic encoder) 105 and AD (arithmetic decoder) 106 components.

FIG. 3A depicts the encoder and decoder in a single figure. As is clear to those skilled in the art, the encoder and the decoder may be, and very often are, embedded in mutually different devices. FIG. 3B depicts the encoder and FIG. 3C depicts the decoder components of the VAE framework in isolation. As input, the encoder receives, according to some embodiments, a picture. The input picture may include one or more channels, such as color channels or other kind of channels, e.g. depth channel or motion information channel, or the like. The output of the encoder (as shown in FIG. 3B) is a bitstream 1 and a bitstream 2. The bitstream 1 is the output of the first sub-network of the encoder and the bitstream 2 is the output of the second subnetwork of the encoder.

Similarly, in FIG. 3C, the two bitstreams, bitstream 1 and bitstream 2, are received as input and, which is the reconstructed (decoded) image, is generated at the output. As indicated above, the VAE can be split into different logical units that perform different actions. This is exemplified in FIGS. 3B and 3C so that FIG. 3B depicts components that participate in the encoding of a signal, like a video and provided encoded information. This encoded information is then received by the decoder components depicted in FIG. 3C for encoding, for example. It should be noted that the components of the encoder and decoder denoted with numerals 12x and 14x may correspond in their function to the components referred to above in FIG. 3A and denoted with numerals 10x.

Specifically, as is seen in FIG. 3B, the encoder comprises the encoder 121 that transforms an input x into a signal y which is then provided to the quantizer 322. The quantizer 122 provides information to the arithmetic encoding module 125 and the hyper encoder 123. The hyper encoder 123 provides the bitstream 2 already discussed above to the hyper decoder 147 that in turn provides the information to the arithmetic encoding module 105 (125).

The output of the arithmetic encoding module is the bitstream 1. The bitstream 1 and bitstream 2 are the output of the encoding of the signal, which are then provided (transmitted) to the decoding process. Although the unit 101 (121) is called “encoder,” it is also possible to call the complete subnetwork described in FIG. 3B as “encoder.” The process of encoding in general means the unit (module) that converts an input to an encoded (e.g. compressed) output. It can be seen from FIG. 3B, that the unit 121 can be actually considered as a core of the whole subnetwork, since it performs the conversion of the input x into y, which is the compressed version of the x. The compression in the encoder 121 may be achieved, e.g. by applying a neural network, or in general any processing network with one or more layers. In such network, the compression may be performed by cascaded processing including downsampling which reduces size and/or number of channels of the input. Thus, the encoder may be referred to, e.g. as a neural network (NN) based encoder, or the like.

The remaining parts in the figure (quantization unit, hyper encoder, hyper decoder, arithmetic encoder/decoder) are all parts that either improve the efficiency of the encoding process or are responsible for converting the compressed output y into a series of bits (bitstream). Quantization may be provided to further compress the output of the NN encoder 121 by a lossy compression. The AE 125 in combination with the hyper encoder 123 and hyper decoder 127 used to configure the AE 125 may perform the binarization which may further compress the quantized signal by a lossless compression. Therefore, it is also possible to call the whole subnetwork in FIG. 3B an “encoder.”

A majority of Deep Learning (DL) based image/video compression systems reduce dimensionality of the signal before converting the signal into binary digits (bits). In the VAE framework for example, the encoder, which is a non-linear transform, maps the input image x into y, where y has a smaller width and height than x. Since the y has a smaller width and height, hence a smaller size, the (size of the) dimension of the signal is reduced, and, hence, it is easier to compress the signal y. It is noted that in general, the encoder does not necessarily need to reduce the size in both (or in general all) dimensions. Rather, some exemplary implementations may provide an encoder which reduces size only in one (or in general a subset of) dimension.

In J. Balle, L. Valero Laparra, and E. P. Simoncelli (2015). “Density Modeling of Images Using a Generalized Normalization Transformation,” In: arXiv e-prints, Presented at the 4th Int. Conf, for Learning Representations, 2016 (referred to in the following as “Balle”) the authors proposed a framework for end-to-end optimization of an image compression model based on nonlinear transforms. The authors optimize for Mean Squared Error (MSE), but use a more flexible transforms built from cascades of linear convolutions and nonlinearities. Specifically, authors use a generalized divisive normalization (GDN) joint nonlinearity that is inspired by models of neurons in biological visual systems, and has proven effective in Gaussianizing image densities. This cascaded transformation is followed by uniform scalar quantization (i.e., each element is rounded to the nearest integer), which effectively implements a parametric form of vector quantization on the original image space. The compressed image is reconstructed from these quantized values using an approximate parametric nonlinear inverse transform.

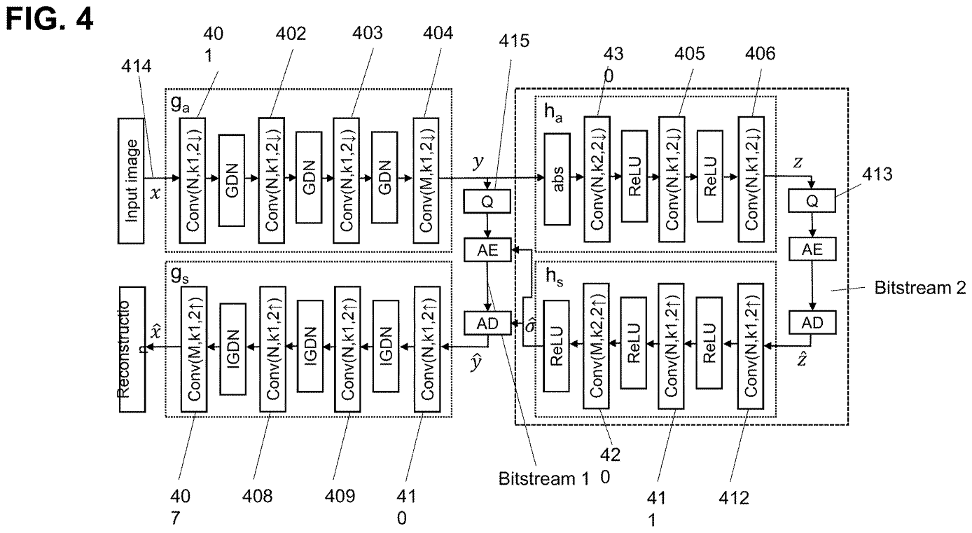

Such example of the VAE framework is shown in FIG. 4, and it utilizes 6 downsampling layers that are marked with 401 to 406. The network architecture includes a hyperprior model. The left side (gₐ, gₛ) shows an image autoencoder architecture, the right side (hₐ, hₛ) corresponds to the autoencoder implementing the hyperprior. The factorized-prior model uses the identical architecture for the analysis and synthesis transforms gₐ and gₛ. Q represents quantization, and AE, AD represent arithmetic encoder and arithmetic decoder, respectively. The encoder subjects the input image x to gₐ, yielding the responses y (latent representation) with spatially varying standard deviations. The encoding gₐ includes a plurality of convolution layers with subsampling and, as an activation function, generalized divisive normalization (GDN).

The responses are fed into hₐ, summarizing the distribution of standard deviations in z. z is then quantized, compressed, and transmitted as side information. The encoder then uses the quantized vector \hat{z} to estimate \hat{σ}, the spatial distribution of standard deviations which is used for obtaining probability values (or frequency values) for arithmetic coding (AE), and uses it to compress and transmit the quantized image representation ŷ (or latent representation). The decoder first recovers \hat{z} from the compressed signal. It then uses hₛ to obtain ŷ, which provides it with the correct probability estimates to successfully recover ŷ as well. It then feeds ŷ into gₛ to obtain the reconstructed image.

The layers that include downsampling is indicated with the downward arrow in the layer description. The layer description “Conv N,k1,2↓” means that the layer is a convolution layer, with N channels and the convolution kernel is k1×k1 in size. For example, k1 may be equal to 5 and k2 may be equal to 3. As stated, the 2↓ means that a downsampling with a factor of 2 is performed in this layer. Downsampling by a factor of 2 results in one of the dimensions of the input signal being reduced by half at the output. In FIG. 4, the 2↓ indicates that both width and height of the input image is reduced by a factor of 2. Since there are 6 downsampling layers, if the width and height of the input image 414 (also denoted with x) is given by w and h, the output signal z\hat{ }413 is has width and height equal to w/64 and h/64 respectively. Modules denoted by AE and AD are arithmetic encoder and arithmetic decoder, which are explained with reference to FIGS. 3A to 3C. The arithmetic encoder and decoder are specific implementations of entropy coding. AE and AD can be replaced by other means of entropy coding. In information theory, an entropy encoding is a lossless data compression scheme that is used to convert the values of a symbol into a binary representation which is a revertible process. Also, the “Q” in the figure corresponds to the quantization operation that was also referred to above in relation to FIG. 4 and is further explained above in the section “Quantization.” Also, the quantization operation and a corresponding quantization unit as part of the component 413 or 415 is not necessarily present and/or can be replaced with another unit.

In FIG. 4, there is also shown the decoder comprising upsampling layers 407 to 412. A further layer 420 is provided between the upsampling layers 411 and 410 in the processing order of an input that is implemented as convolutional layer but does not provide an upsampling to the input received. A corresponding convolutional layer 430 is also shown for the decoder. Such layers can be provided in NNs for performing operations on the input that do not alter the size of the input but change specific characteristics. However, it is not necessary that such a layer is provided.

When seen in the processing order of bitstream 2 through the decoder, the upsampling layers are run through in reverse order, i.e. from upsampling layer 412 to upsampling layer 407. Each upsampling layer is shown here to provide an upsampling with an upsampling ratio of 2, which is indicated by the 1. It is, of course, not necessarily the case that all upsampling layers have the same upsampling ratio and also other upsampling ratios like 3, 4, 8 or the like may be used. The layers 407 to 412 are implemented as convolutional layers (conv). Specifically, as they may be intended to provide an operation on the input that is reverse to that of the encoder, the upsampling layers may apply a deconvolution operation to the input received so that its size is increased by a factor corresponding to the upsampling ratio. However, the present disclosure is not generally limited to deconvolution and the upsampling may be performed in any other manner such as by bilinear interpolation between two neighboring samples, or by nearest neighbor sample copying, or the like.

In the first subnetwork, some convolutional layers (401 to 403) are followed by generalized divisive normalization (GDN) at the encoder side and by the inverse GDN (IGDN) at the decoder side. In the second subnetwork, the activation function applied is ReLu. It is noted that the present disclosure is not limited to such implementation and in general, other activation functions may be used instead of GDN or ReLu.

### Cloud Solutions for Machine Tasks

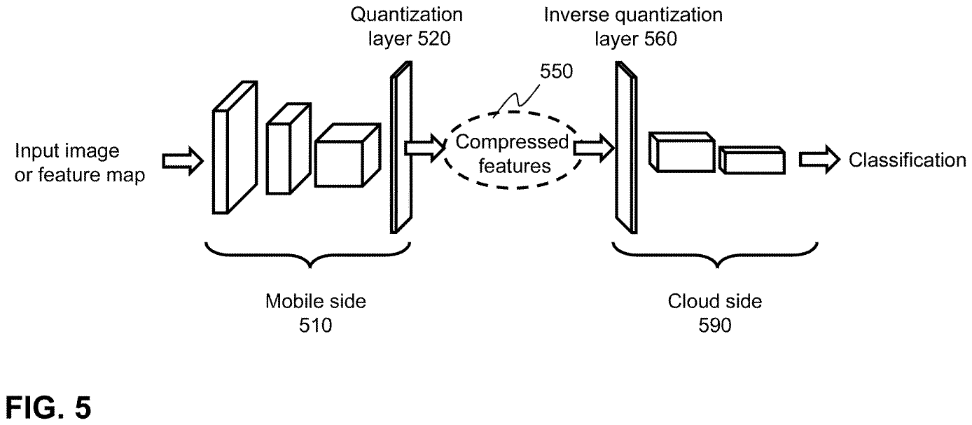

The Video Coding for Machines (VCM) is another computer science direction being popular nowadays. The main idea behind this approach is to transmit a coded representation of image or video information targeted to further processing by computer vision (CV) algorithms, like object segmentation, detection and recognition. In contrast to traditional image and video coding targeted to human perception the quality characteristic is the performance of computer vision task, e.g. object detection accuracy, rather than reconstructed quality. This is illustrated in FIG. 5.

Video Coding for Machines is also referred to as collaborative intelligence and it is a relatively new paradigm for efficient deployment of deep neural networks across the mobile-cloud infrastructure. By dividing the network between the mobile side 510 and the cloud side 590 (e.g. a cloud server), it is possible to distribute the computational workload such that the overall energy and/or latency of the system is minimized. In general, the collaborative intelligence is a paradigm where processing of a neural network is distributed between two or more different computation nodes; for example devices, but in general, any functionally defined nodes. Here, the term “node” does not refer to the above-mentioned neural network nodes. Rather the (computation) nodes here refer to (physically or at least logically) separate devices/modules, which implement parts of the neural network. Such devices may be different servers, different end user devices, a mixture of servers and/or user devices and/or cloud and/or processor or the like. In other words, the computation nodes may be considered as nodes belonging to the same neural network and communicating with each other to convey coded data within/for the neural network. For example, in order to be able to perform complex computations, one or more layers may be executed on a first device (such as a device on mobile side 510) and one or more layers may be executed in another device (such as a cloud server on cloud side 590). However, the distribution may also be finer and a single layer may be executed on a plurality of devices. In this disclosure, the term “plurality” refers to two or more. In some existing solution, a part of a neural network functionality is executed in a device (user device or edge device or the like) or a plurality of such devices and then the output (feature map) is passed to a cloud. A cloud is a collection of processing or computing systems that are located outside the device, which is operating the part of the neural network. The notion of collaborative intelligence has been extended to model training as well. In this case, data flows both ways: from the cloud to the mobile during back-propagation in training, and from the mobile to the cloud (illustrated in FIG. 5) during forward passes in training, as well as inference.

Some works presented semantic image compression by encoding deep features and then reconstructing the input image from them. The compression based on uniform quantization was shown, followed by context-based adaptive arithmetic coding (CABAC) from H.264. In some scenarios, it may be more efficient, to transmit from the mobile part 510 to the cloud 590 an output of a hidden layer (a deep feature map) 550, rather than sending compressed natural image data to the cloud and perform the object detection using reconstructed images. It may thus be advantageous to compress the data (features) generated by the mobile side 510, which may include a quantization layer 520 for this purpose. Correspondingly, the cloud side 590 may include an inverse quantization layer 560. The efficient compression of feature maps benefits the image and video compression and reconstruction both for human perception and for machine vision. Entropy coding methods, e.g. arithmetic coding is a popular approach to compression of deep features (i.e. feature maps).

Nowadays, video content contributes to more than 80% internet traffic, and the percentage is expected to increase even further. Therefore, it is critical to build an efficient video compression system and generate higher quality frames at given bandwidth budget. In addition, most video related computer vision tasks such as video object detection or video object tracking are sensitive to the quality of compressed videos, and efficient video compression may bring benefits for other computer vision tasks. Meanwhile, the techniques in video compression are also helpful for action recognition and model compression. However, in the past decades, video compression algorithms rely on hand-crafted modules, e.g., block based motion estimation and Discrete Cosine Transform (DCT), to reduce the redundancies in the video sequences, as mentioned above. Although each module is well designed, the whole compression system is not end-to-end optimized. It is desirable to further improve video compression performance by jointly optimizing the whole compression system.

### End-to-End Image or Video Compression

DNN based image compression methods can exploit large scale end-to-end training and highly non-linear transform, which are not used in the traditional approaches. However, it is non-trivial to directly apply these techniques to build an end-to-end learning system for video compression. First, it remains an open problem to learn how to generate and compress the motion information tailored for video compression. Video compression methods heavily rely on motion information to reduce temporal redundancy in video sequences.

A straightforward solution is to use the learning based optical flow to represent motion information. However, current learning based optical flow approaches aim at generating flow fields as accurate as possible. The precise optical flow is often not optimal for a particular video task. In addition, the data volume of optical flow increases significantly when compared with motion information in the traditional compression systems and directly applying the existing compression approaches to compress optical flow values will significantly increase the number of bits required for storing motion information. Second, it is unclear how to build a DNN based video compression system by minimizing the rate-distortion based objective for both residual and motion information. Rate-distortion optimization (RDO) aims at achieving higher quality of reconstructed frame (i.e., less distortion) when the number of bits (or bit rate) for compression is given. RDO is important for video compression performance. In order to exploit the power of end-to-end training for learning based compression system, the RDO strategy is required to optimize the whole system.

In Guo Lu, Wanli Ouyang, Dong Xu, Xiaoyun Zhang, Chunlei Cai, Zhiyong Gao; “DVC: An End-to-end Deep Video Compression Framework,” Proceedings of the IEEE/CVF Conference on Computer Vision and Pattern Recognition (CVPR), 2019, pp. 11006-11015, the authors proposed the end-to-end deep video compression (DVC) model that jointly learns motion estimation, motion compression, and residual coding.

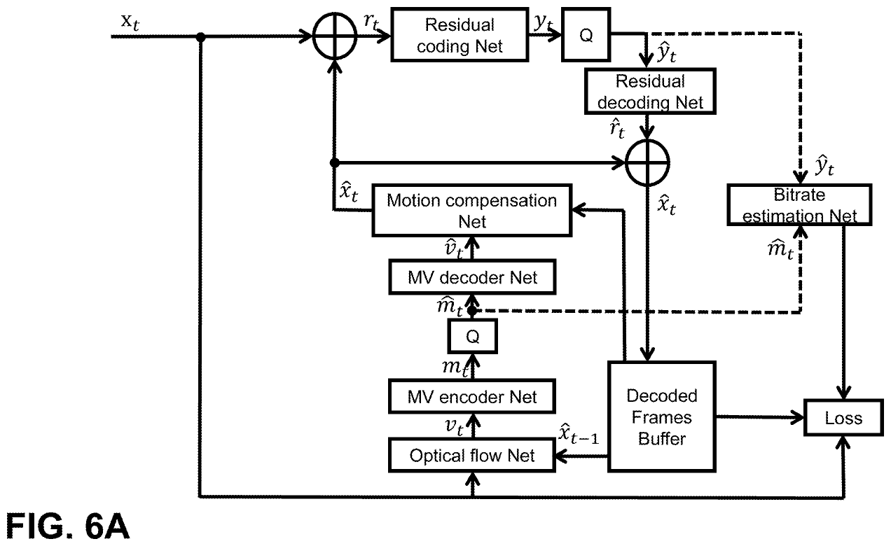

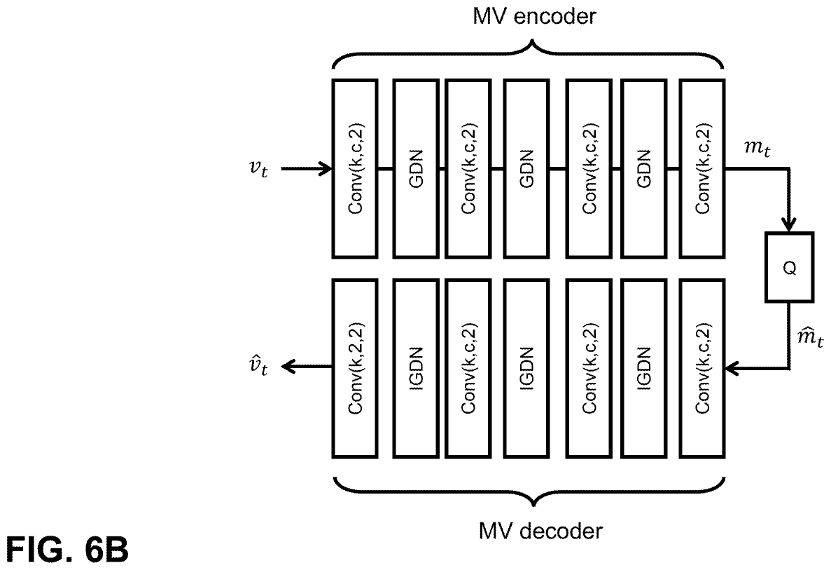

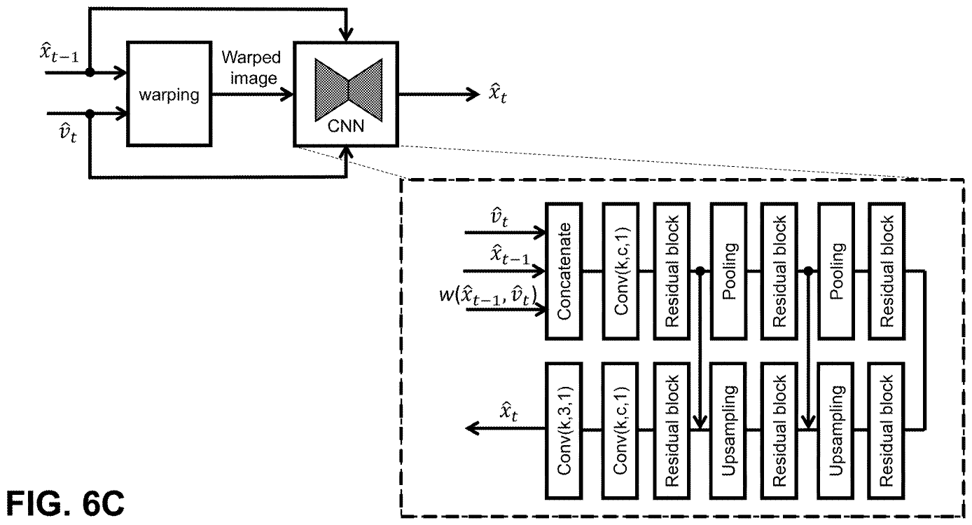

Such an encoder is illustrated in FIG. 6A. FIG. 6A shows an overall structure of end-to-end trainable video compression framework. In order to compress motion information, a CNN was designated to transform the optical flow vₜ to the corresponding representations mₜ suitable for better compression. Specifically, an autoencoder style network is used to compress the optical flow. The motion vectors (MV) compression network is shown in FIG. 6B. The network architecture is somewhat similar to the ga/gs of FIG. 4. The optical flow vₜ is fed into a series of convolution operation and nonlinear transform including GDN and IGDN. The number of output channels c for convolution (deconvolution) is here exemplarily 128 except for the last deconvolution layer, which is equal to 2 in this example. The kernel size is k, e.g. k=3. Given optical flow with the size of M×N×2, the MV encoder will generate the motion representation mₜ with the size of M/16×N/16×128. Then motion representation is quantized (Q), entropy coded and sent to bitstream as \hat{m}ₜ. The MV decoder receives the quantized representation \hat{m}ₜ and reconstruct motion information \hat{v}ₜ using MV encoder. In general, the values for k and c may differ from the above mentioned examples as is known from the art.

FIG. 6C shows a structure of the motion compensation part. Here, using previous reconstructed frame xₜ₋₁ and reconstructed motion information, the warping unit generates the warped frame (normally, with help of interpolation filter such as bi-linear interpolation filter). Then a separate CNN with three inputs generates the predicted picture. The architecture of the motion compensation CNN is also shown in FIG. 6C.

The residual information between the original frame and the predicted frame is encoded by the residual encoder network. A highly non-linear neural network is used to transform the residuals to the corresponding latent representation. Compared with discrete cosine transform in the traditional video compression system, this approach can better exploit the power of non-linear transform and achieve higher compression efficiency.

The above overview illustrates that CNN based architecture can be applied both for image and video compression, considering different parts of video framework including motion estimation, motion compensation and residual coding. Entropy coding is popular method used for data compression, which is widely adopted by the industry and is also applicable for feature map compression either for human perception or for computer vision tasks.

### Video Coding for Machines

The Video Coding for Machines (VCM) is another computer science direction being popular nowadays. The main idea behind this approach is to transmit the coded representation of image or video information targeted to further processing by computer vision (CV) algorithms, like object segmentation, detection and recognition. In contrast to traditional image and video coding targeted to human perception the quality characteristic is the performance of computer vision task, e.g. object detection accuracy, rather than reconstructed quality.

A recent study proposed a new deployment paradigm called collaborative intelligence, whereby a deep model is split between the mobile and the cloud. Extensive experiments under various hardware configurations and wireless connectivity modes revealed that the optimal operating point in terms of energy consumption and/or computational latency involves splitting the model, usually at a point deep in the network. Today's common solutions, where the model sits fully in the cloud or fully at the mobile, were found to be rarely (if ever) optimal. The notion of collaborative intelligence has been extended to model training as well. In this case, data flows both ways: from the cloud to the mobile during back-propagation in training, and from the mobile to the cloud during forward passes in training, as well as inference.

Lossy compression of deep feature data has been studied based on HEVC intra coding, in the context of a recent deep model for object detection. It was noted the degradation of detection performance with increased compression levels and proposed compression-augmented training to minimize this loss by producing a model that is more robust to quantization noise in feature values. However, this is still a sub-optimal solution, because the codec employed is highly complex and optimized for natural scene compression rather than deep feature compression.

The problem of deep feature compression for the collaborative intelligence has been addressed by an approach for object detection task using popular YOLOv2 network for the study of compression efficiency and recognition accuracy trade-off. As used in the present context, the term deep feature has the same meaning as feature map. The word “deep” comes from the collaborative intelligence idea when the output feature map of some hidden (deep) layer is captured and transferred to the cloud to perform inference. That appears to be more efficient rather than sending compressed natural image data to the cloud and perform the object detection using reconstructed images.

The efficient compression of feature maps benefits the image and video compression and reconstruction both for human perception and for machine vision. Disadvantages of state-of-the art autoencoder based approaches to compression are also valid for machine vision tasks.

### Functional Modules

### Variable Bitrate Module

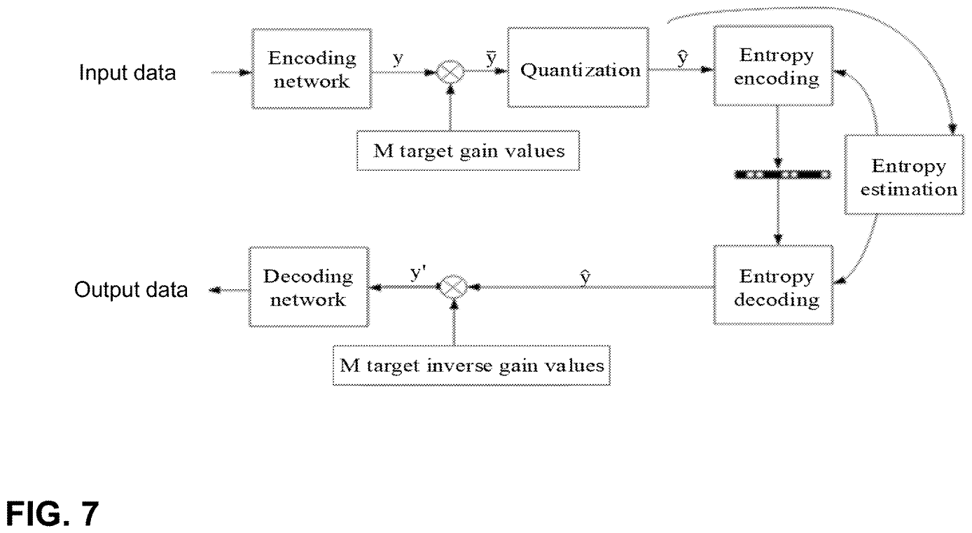

An encoder can output bitstreams at different bit rates. Therefore, in some methods, an output of an encoding network is scaled (for example, each channel is multiplied by a corresponding scaling factor that is also referred to as a target gain value), and an input of a decoding network is inversely scaled (for example, each channel is multiplied by a corresponding scaling factor reciprocal that is also referred to as a target inverse gain value), as shown in FIG. 7. The scaling factor may be preset. Different quality levels or quantization parameters correspond to different target gain values. If the output of the encoding network is scaled to a smaller value, a bitstream size may be decreased. Otherwise, the bitstream size may be increased.

### Color Format Transform

RGB and YUV are common color spaces. Conversion between RGB and YUV may be performed according to an equation specified in standards such as CCIR 601 and BT.709.

### Separate Structure for Luma and Chroma

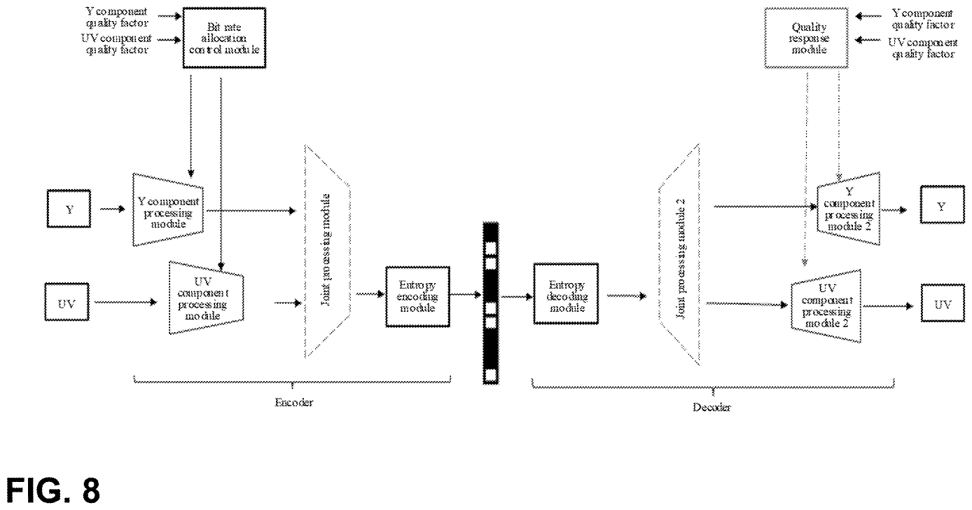

Some VAE-based codecs use the YUV color space as an input of an encoder and an output of a decoder, as shown in FIG. 8. A Y component indicates luma, and a UV component indicates chroma. Resolution of the UV component may be the same as or lower than that of the Y component. Typical formats include YUV4:4:4, YUV4:2:2, and YUV4:2:0. The Y component is converted into a feature map F_Y through a network, and an entropy encoding module generates a bitstream of the Y component based on the feature map F_Y. The UV component is converted into a feature map F_UV through another network, and the entropy encoding module generates a bitstream of the UV component based on the feature map F_UV. Under this structure, the feature map of the Y component and the feature map of the UV component may be independently quantized, so that bits are flexibly allocated for luma and chroma. For example, for a color-sensitive image, a feature map of a UV component may be less quantized, and a quantity of bitstream bits for a UV component may be increased, to improve reconstruction quality of the UV component and achieve better visual effect.

In some other methods, an encoder concatenates (concatenate) a Y component and a UV component and then sends to a UV component processing module (for converting image information into a feature map). In addition, a decoder concatenates a reconstructed feature map of the Y component and a reconstructed feature map of the UV component and then sends to a UV component processing module 2 (for converting a feature map into image information). In this method, a correlation between the Y component and the UV component may be used to reduce a bitstream of the UV component.

In the present disclosure, a “parameter” of a neural network is a value used in an operation process of each layer forming a neural network, and for example, may include a weight used when an input value is applied to a certain operation expression. Here, the parameter may be expressed in a matrix form. The parameter is a value set as a result of training, and may be updated through separate training data when necessary.

Exemplary methods and devices according to embodiments of the present disclosure will now be described in further detail.

As mentioned previously, skip modes are more efficient in image areas where the prediction quality is good. In this case, less information can be transmitted and subsequently decoded. It would therefore be desirable to transmit different skip parameters in areas where the prediction is of high quality. However, it is not generally possible for the decoder to know where in the image the prediction quality is good, since this requires a ground truth, which is not available at the decoder.

In the present disclosure, an estimated motion, which may be embodied as a motion complexity measure, is used to classify image areas. This can serve as estimate for the prediction quality, since areas with high motion complexity are often more difficult to compress. Each part of the image can therefore be assigned a value of a motion complexity measure. The motion complexity measure for a part of the image can be determined based on motion in a region of the image associated with the part. For each region of a state of the video stream (e.g. a frame), the motion is determined between that region in that state and one or more corresponding regions in other states of the video stream. The region in that state and the corresponding region in other states may be collocated blocks. The current state may be a frame of the video stream and motion may be determined between regions of that frame and the corresponding region in an adjacent (e.g. previous) frame. The region may be a larger area than the part, or vice versa. For example, the region may be a block of pixels and the associated part may be a single pixel. A part may be comprised in its associated region. For example, the part may be a central pixel of a region comprising a block of pixels.

This motion complexity measure can be used to classify each part of the image into one of N classes. For each of the N classes, skip information is signalled to the decoder. This could be whether the entire area of parts having that class is to be skipped, or for example an individual threshold may be used for a variance-threshold-based approach to determine the areas to be skipped.

The coder can therefore use transmitted motion information to compute a respective motion complexity measure for each part of the image and classify parts of the image (such as latent space positions) in dependence on their respective measures. Skip (or skip parameters) can be transferred for each class separately.

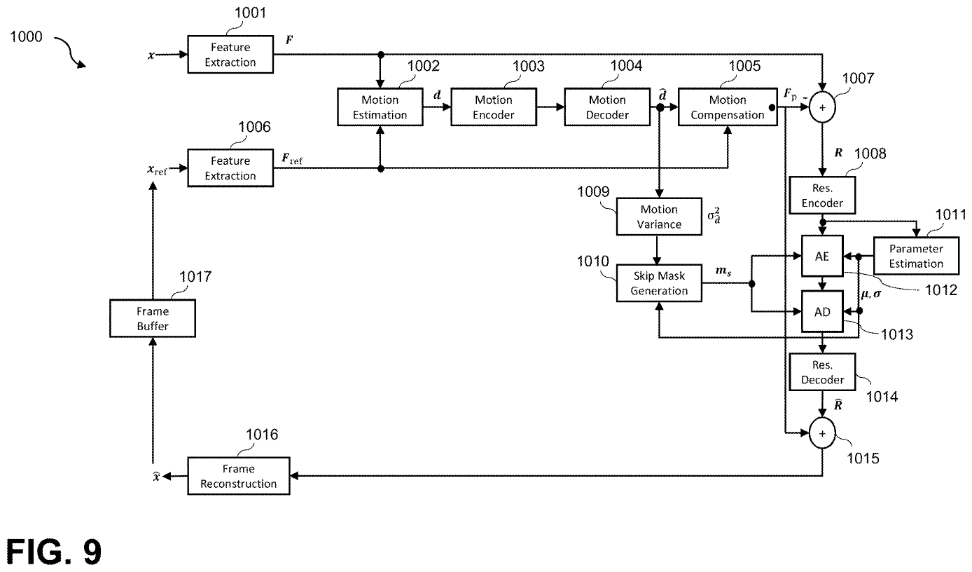

A high-level diagram of the coder 1000 is schematically illustrated in FIG. 9. The feature extraction modules 1001, 1006 and the frame buffer 1017 may perform their operations in the pixel space. The other modules in this example are performed in the feature space. However, the process may also be performed in image space or a latent space.

x is an input state of the video stream at the current time step. In the video compression system, the objective is to produce a reconstructed frame \hat{x} at any given bit-rate. Given an input state x of the video stream, where in this example the state is a frame of the video stream, the input frame x is encoded at the feature extraction module 1001 to extract features from the input frame to produce the input feature F.

To produce the representations in the feature space, the original input frame x and the previous reconstructed frame x_{ref} are encoded as the feature representations F and F_{ref}, respectively. In one example, feature extraction modules 1001, 1006 use a convolution layer with a stride of 2, which is then followed by several residual blocks to produce the respective feature representation F, F_{ref}.

At motion estimation module 1002, motion is estimated for each of multiple regions of the input frame x. In this example, the offset map d between the features F and F_{ref} from the reference frame (which may be the previous frame) x_{ref} is estimated and then used as motion information for the frame x. Features are extracted from the reference state x_{ref} at feature extraction module 1006 to output the extracted reference features F_{ref}. The offset map d is then compressed using a motion encoder 1003 and the reconstructed offset map \hat{d} is output by a motion decoder 1004. In this example, the offset map d is transformed to the latent space through the motion encoder 1003 and then quantized. After that, the motion decoder 1004 can convert the quantized latent representations back to the reconstructed offset map \hat{d}.

The reconstructed offset map \hat{d} is employed for motion compensation at module 1005. This may be done using a deformable convolution operation. Given the features F_{ref} and F from the previous reconstructed frame and the current frame respectively, the motion compensation module 1005 aims at generating the predicted feature Fₚ at the current time step.

In one example, based on F and F_{ref}, motion estimation is performed at 1002 by using a lightweight network, and the output offset map d can be compressed before being transmitted to the decoder side 1004. Finally, given the reconstructed offset map \hat{d} and the feature F_{ref}, the predicted feature Fₚ can be generated by using a deformable convolution.

In the motion compensation module 1005, the deformable convolution layer takes F_{ref} as the input and then performs, for example, a deformable convolution operation by using the corresponding filters with the aid of \hat{d} output by the decoder 1004. To generate a more accurate predicted feature, the output feature from the deformable convolution layer can be refined, for example by using two convolution layers, to produce the final predicted feature Fₚ.

The residual feature R between the input feature F and the predicted feature Fₚ is then determined at 1007 and compressed in a residual compression module comprising multiple elements to form a reconstructed feature residual \hat{R}, as will be described in more detail below.

In this example, the residual feature R between the input feature F and the predicted feature Fₚ is compressed using an auto-encoder.

The residual encoder 1008 is the encoder component of the autoencoder. It generates the latent representation, which is transmitted by an arithmetic entropy coder (AE) 1012, or a different entropy coder. The arithmetic decoder (AD) 1013 decodes the bitstream and reconstructs the latent representation which is used by the residual decoder 1014 to reconstruct the feature space residual \hat{R}.

The parameter estimation module 1011 estimates a probability density function (for example, a Laplacian or Gaussian) characterized by mean μ and scale/variance (measure of spread) σ parameters. Both encoder 1012 and decoder 1013 know the value of σ of each symbol. When a symbol has a lower measure of spread (for example σ or σ²) than a threshold θᵢ, its transmission can be skipped since it probably does not contain enough new information to be of significance to the reconstructed signal. This method is equivalent to setting a threshold on the maximal probability for a single value.

After adding the reconstructed residual feature \hat{R} back to the predicted feature Fₚ at 1015, the frame is reconstructed at 1016 to give \hat{x}. The reconstructed frame \hat{x} can be stored in a frame buffer 1017 and used as the reference frame x_{ref} for the motion estimate and compensation for the next frame.

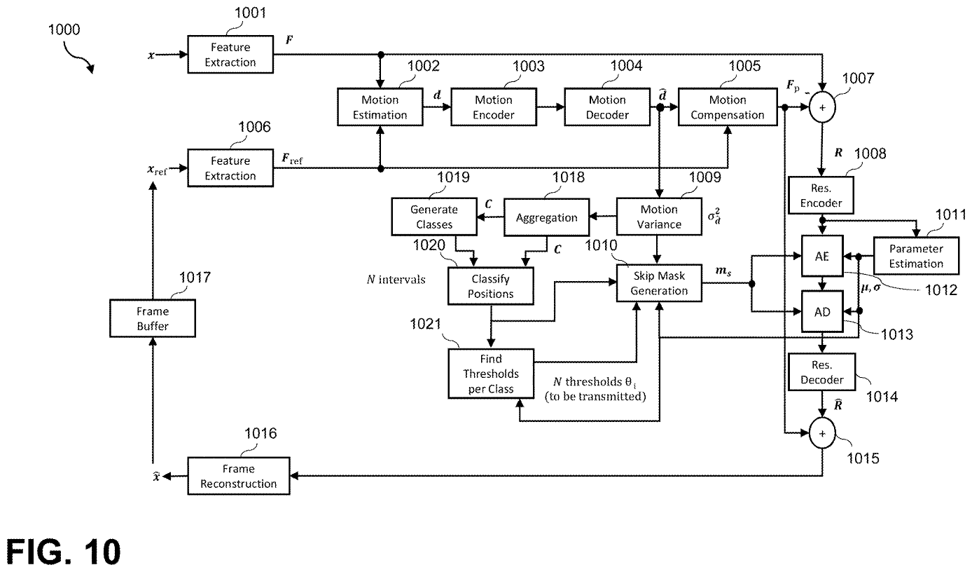

In one example, as will now be described with reference to FIG. 10, \hat{d} output from the motion decoder 1004 is used to determine a motion variance

$${σ}_{\hat{d}}^{2}$$

for the respective region of the frame for which motion has been estimated at 1009. This is then used to generate a skip mask mₛ at 1010 that is used by AE 1012 and AD 1013. The formation of the skip mask will be described in more detail below.

The residual feature R comprises multiple symbols (which are data blocks). In one implementation, at 1021 the coder 1000 can determine and signal one out of multiple (for example, 8) pre-defined thresholds θᵢ which are then used for skipping individual symbols in the following way. For entropy coding a hyper-prior network at 1011 estimates the average (the mean in this example) u and scale/variance parameter σ (i.e. measure of spread) of a Gaussian distribution for each symbol. For every symbol or data block which has an estimated measure of spread (for example, variance σ² or standard deviation σ) smaller than the signalled threshold θᵢ, the symbol or data block is not transmitted and instead the estimated average (e.g. mean) μ for that symbol or data block is used for further processing at the decoder side. Since the decoder 1013 knows the threshold and the estimated measure of spread (e.g. variance) and average, the decoder 1013 can also derive the skipped symbols or data blocks and decode them accordingly.

Therefore, for symbols or data blocks where the estimated measure of spread (e.g. σ²) is smaller than the threshold θᵢ, the symbol or data block is not encoded and is not transmitted to the decoder for decoding (i.e. it is skipped). At the decoder side (1013, 1014), the estimated average (e.g. mean) μ is used for further processing. For symbols or data blocks where the estimated measure of spread is greater than the threshold θᵢ, the symbol is encoded and is transmitted to the decoder for decoding (i.e. it is not skipped). For the skipped parts, the estimated average value μ is used to reconstruct the residual for those parts.

In other words, the reconstructed residual \hat{R} can be formed by decoding encoded data corresponding to non-skipped parts of the state and using the estimated average μ for data corresponding to skipped parts of the state.

In the embodiment shown in FIG. 10, the motion variance

$${σ}_{\hat{d}}^{2}$$

is used as criterion to refine the skip modes. The local motion variance is computed from the decoded displacement field \hat{d} output by motion decoder 1004.

Traditional motion vectors may be used for inter-prediction, or other methods may be used, such as a set of 64 parameters per position which steer deformable convolutions.

From these parameters, the channel wise variance of a 3×3 window around every position (m, n) can be computed as follows, where c is the channel:

$${σ}_{\hat{d}}^{2} [ m , n , c ] = var ( \{ \hat{d} [ {m}^{′} , {n}^{′} , c ] ‖ m - {m}^{′} \vert \leq 1 , \vert n - {n}^{′} \vert \leq 1 \} )$$

m′ and n′ are position indices for \hat{d}. They occur in the definition of the region for which the motion variance is computed. The region contains \hat{d} at positions (m′,n′,c) where the distance between m and m′ as well as n and n′ does not exceed 1 (i.e. they are within a 3×3 window around (m,n)).

This local motion variance has the same spatial resolution as the displacement field d, which is a factor of 2×2 smaller than the original image (the same dimension as the feature representation F). Padding can be applied to obtain centered 3×3 windows. The latent space has a 16×16 lower resolution than the original image in image space. Therefore, an 8×8 block of

$${σ}_{\hat{d}}^{2}$$

can be aggregated at 1018 to obtain a criterion which is suitable for classifying positions in the latent space. Furthermore, all channels can be aggregated.

In an embodiment of the present disclosure, an aggregation with a sum is used. However, other methods are possible.

The motion complexity measure C for the position (m, n) can be computed in the following way:

$$C [ m , n ] = {\sum }_{( {m}^{′} , {n}^{′} ) ∈ {ℬ}_{8 \times 8} ( m , n )} {\sum }_{c} {σ}_{\hat{d}}^{2} [ {m}^{′} , {n}^{′} , c ]$$

Here, [symbol] _{8×8}(m, n) denotes the corresponding 8×8 block in the feature domain for the position (m, n) in the latent domain. Now every position (m, n) has one value in C assigned to it.

At module 1019, a plurality of classes are generated. The positions, with their corresponding values of C, can be classified at 1020.

The plurality of classes may be defined in different ways. The plurality of classes may be defined by splitting the interval

$$[ {min}_{m , n} C [ m , n ] ; {max}_{m , n} C [ m , n ] ]$$

for a respective state into N sub-intervals and each part may be assigned a class according to the sub-interval in which the corresponding value of C[m, n] falls, where C is the motion complexity measure, m, n is a spatial position in a latent representation of the state of the video stream and N is the number of classes.

The plurality of classes may be defined by splitting the interval

$$[ {min}_{m , n} C [ m , n ] ; {max}_{m , n} C [ m , n ] ]$$

for a respective state into N non-overlapping sub-intervals of equal size. The plurality of classes may alternatively be defined by splitting the interval

$$[ {min}_{m , n} C [ m , n ] ; {max}_{m , n} C [ m , n ] ]$$

for a respective state into N sub-intervals of unequal size. Alternatively, each part may be assigned a class based on fixed and/or predetermined ranges of the motion complexity measure.

Each position can be assigned a class label i according to the index of the subinterval in which the corresponding value of C[m, n] falls.

At module 1021, a threshold can be searched and transmitted for each of the N classes individually. Since the decoder 1013 knows the reconstructed displacement field \hat{d} (as it is transmitted between the motion encoder 1003 and the motion decoder 1004 and as part of the bitstream), the same classification can be done there and together with the transmitted thresholds, the decoder can derive the positions of the skipped values.

The thresholds θᵢ can be determined in a rate-distortion search. For each class i and each possible threshold, the required rate and the resulting image distortion between x and \hat{x} are measured. For each class the threshold with the lowest rate distortion cost R+βD, where R is the rate and D is the distortion is selected. β denotes the weighting between rate and distortion which depends on the desired rate point. The rate-distortion search may be performed as full search, testing all possible combinations, assuming independence between the classes to achieve a faster search, or may use a different fast search strategy.

Each part of the image frame is thus classified into one of a plurality of classes based on the estimated motion for the respective associated region. Specifically, each part is classified into one of the plurality of classes based on the motion complexity measure for the respective part.

At module 1010, a skip mask can be formed. The mask is formed by evaluating the threshold-based skip mode in the spatial positions belonging to each class. In one example, using the variance σ², the mask can be given as:

$$s [ m , n , c ] = \{ \begin{matrix}1 & if {σ}^{2} [ m , n , c ] < {θ}_{i} \\ 0 & if {σ}^{2} [ m , n , c ] \geq {θ}_{i}\end{matrix} ∀ m , n : C [ m , n ] ∈ {\text{?}}_{i}$$

This is performed for each class i which has the associated interval [symbol] ᵢ and threshold θᵢ. The mask gives skip information for each value of the latent space (across both the spatial and the channel dimension) to indicate whether it is skipped (s=1) or not (s=0).

The region of the frame for which motion is estimated may be different to the part of the frame for which C is determined and for which it is determined whether the part should be skipped or not. In one example, the region may be a block of pixels and the part may be a single pixel, or vice versa. The region may be a larger or smaller area of the image frame than the part to be skipped.

In some cases, no parts of the frame may be skipped if the determined motion complexity measures for each of the parts of the image indicate that all of the parts have motion greater than a threshold.

Therefore, symbols of the bitstream can be grouped to transmit a skip mode efficiently. This motion-based method can create spatial groups of an image that are then skipped or not skipped accordingly.

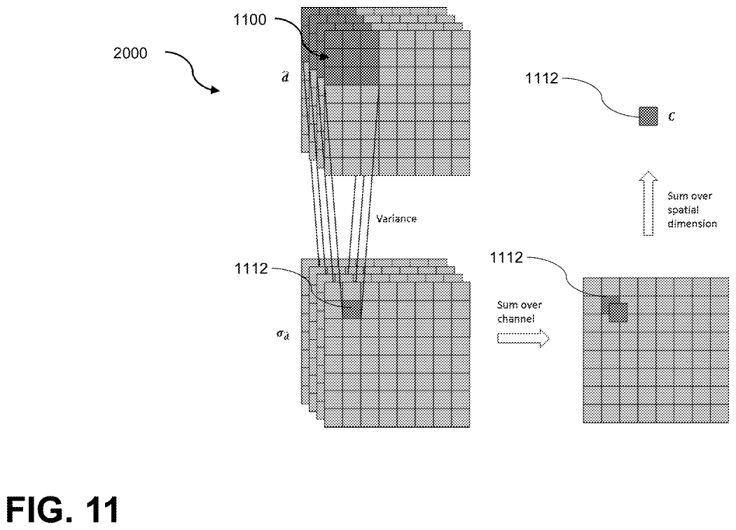

FIG. 11 shows the aggregation of the motion complexity measure C for a video stream 2000 comprising multiple frames. A motion variance is determined for a block of pixels 1100. In this example, the block is a 3×3 block of pixels. The variance for the block is assigned to the central pixel of the block 1112. The variance is summed over the channel and then summed over a spatial dimension to form C for a part of the image, which in this example is the central pixel 1112 for the 3×3 pixel region for which the motion variance

$${σ}_{\hat{d}}^{2}$$

is determined.

The spatial aggregation allows different dimensions of motion and features to be handled. In this example, the aggregation over the spatial dimension can allow the dimension of the motion field to be matched to the dimension of the latent space.

Multiple alternative implementations are possible using the features of the present disclosure.

In the example shown in FIG. 10, a local motion variance is used as the motion complexity measure for the parts of the image. However, alternative motion complexity measures may be used, such as motion entropy, channel-weighted motion variance and learning-based criteria.

Alternative methods of spatial aggregation may also be used. For example, the value of C for a part of the state of the video stream may be determined by taking the maximal value of each pixel in an 8×8 block. It may alternatively be determined by the aggregation of wider (overlapping) blocks.

As mentioned above, alternative methods of splitting the range of the motion complexity parameter may be used to define the multiple classes. These may include splitting the range into fixed intervals (e.g. determined on training set) or into differently spaced intervals (e.g. logarithmic, histogram-based, etc.).

Alternative skip signalling methods may be used. For example, the coder may signal channels to skip for each class, or signal to skip an entire class.

In some examples, the method may be adapted to dimensions required by the coder. In the example described above, an 8×8 block is aggregated, however other dimensions may be used.

In some examples, the nature of motion information may change (in the above 64 features are used), but more or less features or motion vectors may be used.

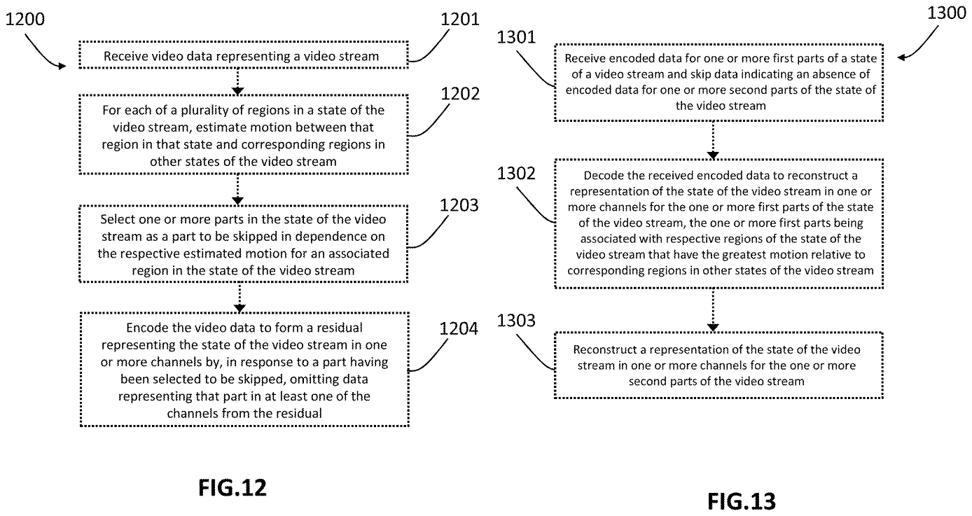

FIG. 12 is a flow diagram illustrating an exemplary method 1200 for encoding image data based on a neural network architecture. The embodiment according to FIG. 12 may be configured to provide output readily decoded by the decoding method described with reference to FIG. 13. The method 1200 of FIG. 12 will be described as being performed by a neural network system of one or more computers located in one or more locations. For example, a system configured to perform image compression, e.g., the neural network of FIG. 1 can perform the method 1200.

At step 1201, the method comprises receiving encoded data for one or more first parts of a state of a video stream and skip data indicating an absence of encoded data for one or more second parts of the state of the video stream. At step 1202, the method comprises decoding the received encoded data to reconstruct a representation of the state of the video stream in one or more channels for the one or more first parts of the state of the video stream, the one or more first parts being associated with respective regions of the state of the video stream that have the greatest motion relative to corresponding regions in other states of the video stream. At step 1203, the method comprises reconstructing a representation of the state of the video stream in one or more channels for the one or more second parts of the video stream.

FIG. 13 is a flow diagram illustrating an exemplary method 1300 for decoding image data based on a neural network architecture. The method 1300 of FIG. 13 will be described as being performed by a neural network system of one or more computers located in one or more locations. For example, a system configured to perform image compression or decompression, e.g., the neural network of FIG. 1 can perform the method 1300.

At step 1301, the method comprises receiving encoded data for one or more first parts of a state of a video stream and skip data indicating an absence of encoded data for one or more second parts of the state of the video stream. At step 1302, the method comprises decoding the received encoded data to reconstruct a representation of the state of the video stream in one or more channels for the one or more first parts of the state of the video stream, the one or more first parts being associated with respective regions of the state of the video stream that have the greatest motion relative to corresponding regions in other states of the video stream. At step 1303, the method comprises reconstructing a representation of the state of the video stream in one or more channels for the one or more second parts of the video stream.

While operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Embodiments of the present disclosure have been described. Other embodiments are within the scope of the present disclosure. As one example, the processes depicted in the accompanying figures do not necessarily require the particular order shown, or sequential order, to achieve desirable results. In certain implementations, multitasking and parallel processing may be advantageous.

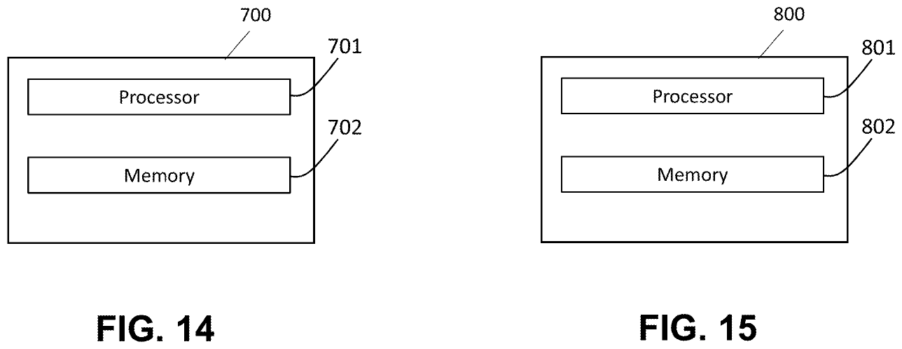

FIG. 14 shows a device 700 for encoding for processing by a neural network based unit, based on the method of FIG. 12. FIG. 15 shows a device 800 for decoding for processing by a neural network based unit, based on the method of FIG. 13.

Each device 700, 800 comprises a processor 701, 801 and a memory 702, 802. The processor may be implemented as dedicated hardware. Alternatively, the processor may be implemented as a computer program running on a programmable device such as a central processing unit (CPU). The respective memory is arranged to communicate with the respective processor. Memory may be a non-volatile memory. Each device may comprise more than one processor and more than one memory. The memory may store data (i.e. the memory is a data carrier) that is executable by the processor. By executing program code contained in such data, the one or more processors may perform functions as described herein. The memory may store such program code in a non-transitory manner. The processor may be configured to operate in accordance with a computer program stored in non-transitory form on a machine readable storage medium. The computer program may store instructions for causing the processor to perform its methods in the manner described herein.

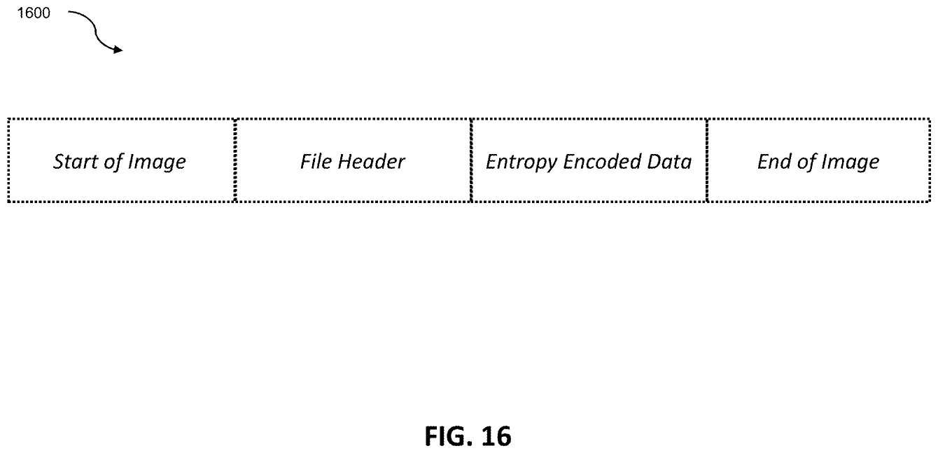

FIG. 16 illustrates one example of a bitstream. The bitstream may comprise a marker indicating the start of the bitstream, header data including, for example, picture header data or tool header data, entropy-encoded data, and optionally padding which may include an end of code stream marker. In one example, the bitstream comprises blocks of data, each block of data being decodable to reconstruct a representation of a respective first part of the state of the video stream, and the bitstream comprising skip data indicating an absence from the bitstream of such a block of data for one or more second parts of the state of the video stream, wherein the one or more first parts are associated with regions of the state of the video stream that have the greatest motion relative to corresponding regions in other states of the video stream. The bitstream may be non-transient. The bitstream may be stored on a data carrier.

### Some Exemplary Implementations in Hardware and Software

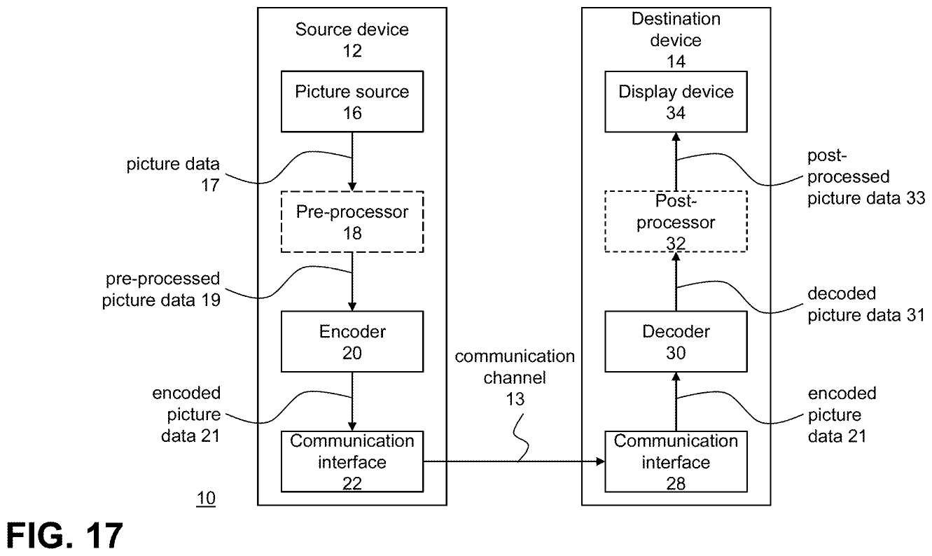

The corresponding system which may deploy the above-mentioned encoder-decoder processing chain is illustrated in FIG. 17. FIG. 17 is a schematic block diagram illustrating an example coding system, e.g. a video, image, audio, and/or other coding system (or short coding system) that may utilize techniques of the present disclosure. Video encoder 20 (or short encoder 20) and video decoder 30 (or short decoder 30) of video coding system 10 represent examples of devices that may be configured to perform techniques in accordance with various examples described in the present application. For example, the video coding and decoding may employ neural network such which may be distributed and which may apply the above-mentioned bitstream parsing and/or bitstream generation to convey feature maps between the distributed computation nodes (two or more).

As shown in FIG. 17, the coding system 10 comprises a source device 12 configured to provide encoded picture data 21 e.g. to a destination device 14 for decoding the encoded picture data 13.

The source device 12 comprises an encoder 20, and may additionally, i.e. optionally, comprise a picture source 16, a pre-processor (or pre-processing unit) 18, e.g. a picture pre-processor 18, and a communication interface or communication unit 22.

The picture source 16 may comprise or be any kind of picture capturing device, for example a camera for capturing a real-world picture, and/or any kind of a picture generating device, for example a computer-graphics processor for generating a computer animated picture, or any kind of other device for obtaining and/or providing a real-world picture, a computer generated picture (e.g. a screen content, a virtual reality (VR) picture) and/or any combination thereof (e.g. an augmented reality (AR) picture). The picture source may be any kind of memory or storage storing any of the aforementioned pictures.

In distinction to the pre-processor 18 and the processing performed by the pre-processing unit 18, the picture or picture data 17 may also be referred to as raw picture or raw picture data 17.

Pre-processor 18 is configured to receive the (raw) picture data 17 and to perform pre-processing on the picture data 17 to obtain a pre-processed picture 19 or pre-processed picture data 19. Pre-processing performed by the pre-processor 18 may, e.g., comprise trimming, color format conversion (e.g. from RGB to YCbCr), color correction, or de-noising. It can be understood that the pre-processing unit 18 may be optional component. It should be noted that the pre-processing may also employ a neural network (such as in any of FIGS. 1 to 7) which uses the presence indicator signaling.

The video encoder 20 is configured to receive the pre-processed picture data 19 and provide encoded picture data 21.

Communication interface 22 of the source device 12 may be configured to receive the encoded picture data 21 and to transmit the encoded picture data 21 (or any further processed version thereof) over communication channel 13 to another device, e.g. the destination device 14 or any other device, for storage or direct reconstruction.

The destination device 14 comprises a decoder 30 (e.g. a video decoder 30), and may additionally, i.e. optionally, comprise a communication interface or communication unit 28, a post-processor 32 (or post-processing unit 32) and a display device 34.

The communication interface 28 of the destination device 14 is configured receive the encoded picture data 21 (or any further processed version thereof), e.g. directly from the source device 12 or from any other source, e.g. a storage device, e.g. an encoded picture data storage device, and provide the encoded picture data 21 to the decoder 30.

The communication interface 22 and the communication interface 28 may be configured to transmit or receive the encoded picture data 21 or encoded data 13 via a direct communication link between the source device 12 and the destination device 14, e.g. a direct wired or wireless connection, or via any kind of network, e.g. a wired or wireless network or any combination thereof, or any kind of private and public network, or any kind of combination thereof.

The communication interface 22 may be, e.g., configured to package the encoded picture data 21 into an appropriate format, e.g. packets, and/or process the encoded picture data using any kind of transmission encoding or processing for transmission over a communication link or communication network.

The communication interface 28, forming the counterpart of the communication interface 22, may be, e.g., configured to receive the transmitted data and process the transmission data using any kind of corresponding transmission decoding or processing and/or de-packaging to obtain the encoded picture data 21.

Both, communication interface 22 and communication interface 28 may be configured as unidirectional communication interfaces as indicated by the arrow for the communication channel 13 in FIG. 17 pointing from the source device 12 to the destination device 14, or bi-directional communication interfaces, and may be configured, e.g. to send and receive messages, e.g. to set up a connection, to acknowledge and exchange any other information related to the communication link and/or data transmission, e.g. encoded picture data transmission. The decoder 30 is configured to receive the encoded picture data 21 and provide decoded picture data 31 or a decoded picture 31.

The post-processor 32 of destination device 14 is configured to post-process the decoded picture data 31 (also called reconstructed picture data), e.g. the decoded picture 31, to obtain post-processed picture data 33, e.g. a post-processed picture 33. The post-processing performed by the post-processing unit 32 may comprise, e.g. color format conversion (e.g. from YCbCr to RGB), color correction, trimming, or re-sampling, or any other processing, e.g. for preparing the decoded picture data 31 for display, e.g. by display device 34.

The display device 34 of the destination device 14 is configured to receive the post-processed picture data 33 for displaying the picture, e.g. to a user or viewer. The display device 34 may be or comprise any kind of display for representing the reconstructed picture, e.g. an integrated or external display or monitor. The displays may, e.g. comprise liquid crystal displays (LCD), organic light emitting diodes (OLED) displays, plasma displays, projectors, micro LED displays, liquid crystal on silicon (LCoS), digital light processor (DLP) or any kind of other display.

Although FIG. 17 depicts the source device 12 and the destination device 14 as separate devices, embodiments of devices may also comprise both or both functionalities, the source device 12 or corresponding functionality and the destination device 14 or corresponding functionality. In such embodiments the source device 12 or corresponding functionality and the destination device 14 or corresponding functionality may be implemented using the same hardware and/or software or by separate hardware and/or software or any combination thereof.

As will be apparent for the skilled person based on the description, the existence and (exact) split of functionalities of the different units or functionalities within the source device 12 and/or destination device 14 as shown in FIG. 17 may vary depending on the actual device and application.

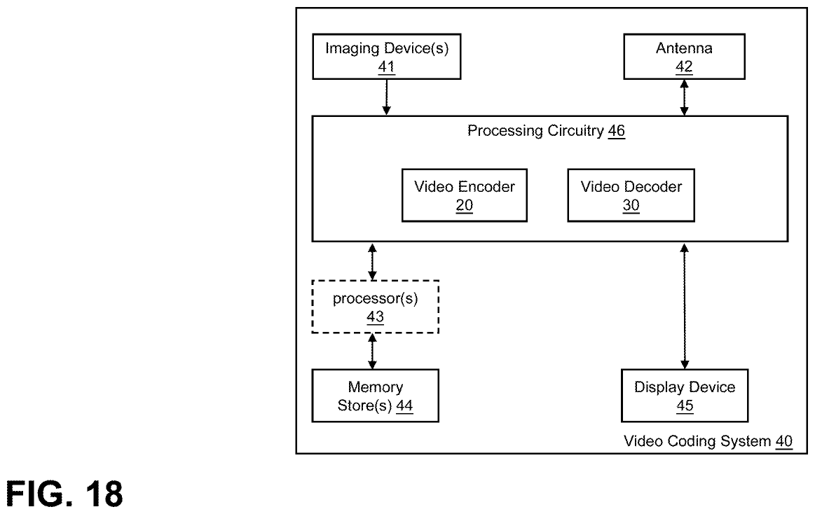

The encoder 20 (e.g. a video encoder 20) or the decoder 30 (e.g. a video decoder 30) or both encoder 20 and decoder 30 may be implemented via processing circuitry, such as one or more microprocessors, digital signal processors (DSPs), application-specific integrated circuits (ASICs), field-programmable gate arrays (FPGAs), discrete logic, hardware, video coding dedicated or any combinations thereof. The encoder 20 may be implemented via processing circuitry 46 to embody the various modules including the neural network or its parts. The decoder 30 may be implemented via processing circuitry 46 to embody any coding system or subsystem described herein. The processing circuitry may be configured to perform the various operations as discussed later. If the techniques are implemented partially in software, a device may store instructions for the software in a suitable, non-transitory computer-readable storage medium and may execute the instructions in hardware using one or more processors to perform the techniques of this disclosure. Either of video encoder 20 and video decoder 30 may be integrated as part of a combined encoder/decoder (CODEC) in a single device, for example, as shown in FIG. 18.

Source device 12 and destination device 14 may comprise any of a wide range of devices, including any kind of handheld or stationary devices, e.g. notebook or laptop computers, mobile phones, smart phones, tablets or tablet computers, cameras, desktop computers, set-top boxes, televisions, display devices, digital media players, video gaming consoles, video streaming devices (such as content services servers or content delivery servers), broadcast receiver device, broadcast transmitter device, or the like and may use no or any kind of operating system. In some cases, the source device 12 and the destination device 14 may be equipped for wireless communication. Thus, the source device 12 and the destination device 14 may be wireless communication devices.

In some cases, video coding system 10 illustrated in FIG. 17 is merely an example and the techniques of the present application may apply to video coding settings (e.g., video encoding or video decoding) that do not necessarily include any data communication between the encoding and decoding devices. In other examples, data is retrieved from a local memory, streamed over a network, or the like. A video encoding device may encode and store data to memory, and/or a video decoding device may retrieve and decode data from memory. In some examples, the encoding and decoding is performed by devices that do not communicate with one another, but simply encode data to memory and/or retrieve and decode data from memory.

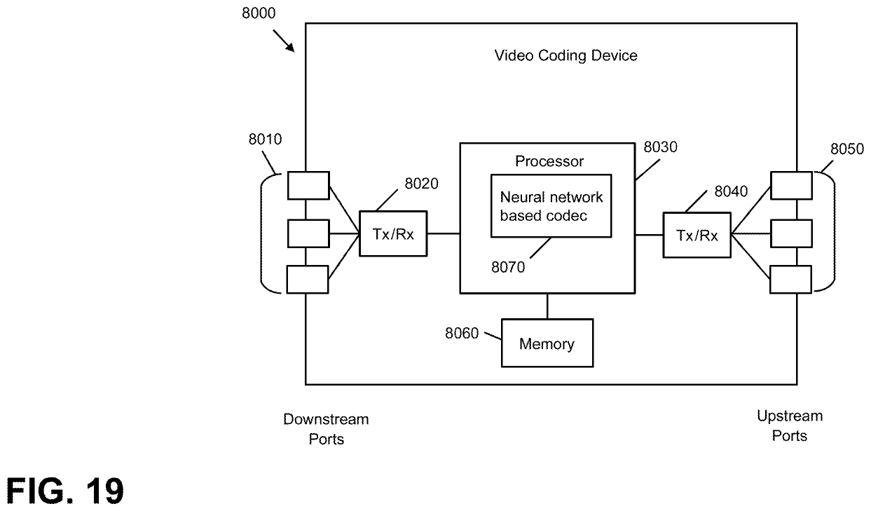

FIG. 19 is a schematic diagram of a video coding device 8000 according to an embodiment of the disclosure. The video coding device 8000 is suitable for implementing the disclosed embodiments as described herein. In an embodiment of the present disclosure, the video coding device 8000 may be a decoder such as video decoder 30 of FIG. 17 or an encoder such as video encoder 20 of FIG. 17.

The video coding device 8000 comprises ingress ports 8010 (or input ports 8010) and receiver units (Rx) 8020 for receiving data; a processor, logic unit, or central processing unit (CPU) 8030 to process the data; transmitter units (Tx) 8040 and egress ports 8050 (or output ports 8050) for transmitting the data; and a memory 8060 for storing the data. The video coding device 8000 may also comprise optical-to-electrical (OE) components and electrical-to-optical (EO) components coupled to the ingress ports 8010, the receiver units 8020, the transmitter units 8040, and the egress ports 8050 for egress or ingress of optical or electrical signals.

The processor 8030 is implemented by hardware and software. The processor 8030 may be implemented as one or more CPU chips, cores (e.g., as a multi-core processor), FPGAs, ASICs, and DSPs. The processor 8030 is in communication with the ingress ports 8010, receiver units 8020, transmitter units 8040, egress ports 8050, and memory 8060. The processor 8030 comprises a neural network based codec 8070. The neural network based codec 8070 implements the disclosed embodiments described above. For instance, the neural network based codec 8070 implements, processes, prepares, or provides the various coding operations. The inclusion of the neural network based codec 8070 therefore provides a substantial improvement to the functionality of the video coding device 8000 and effects a transformation of the video coding device 8000 to a different state. Alternatively, the neural network based codec 8070 is implemented as instructions stored in the memory 8060 and executed by the processor 8030.

The memory 8060 may comprise one or more disks, tape drives, and solid-state drives and may be used as an over-flow data storage device, to store programs when such programs are selected for execution, and to store instructions and data that are read during program execution. The memory 8060 may be, for example, volatile and/or non-volatile and may be a read-only memory (ROM), random access memory (RAM), ternary content-addressable memory (TCAM), and/or static random-access memory (SRAM).

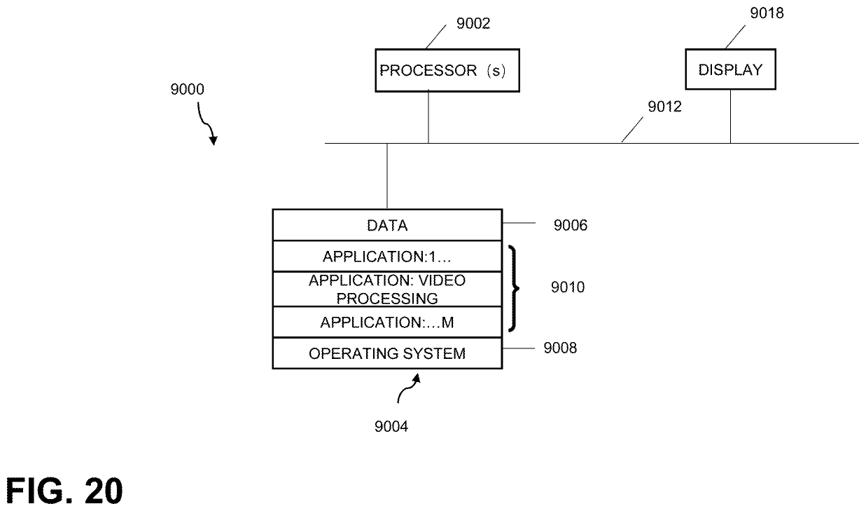

FIG. 20 is a simplified block diagram of an apparatus that may be used as either or both of the source device 12 and the destination device 14 from FIG. 17 according to an exemplary embodiment of the present disclosure.

A processor 9002 in the apparatus 9000 can be a central processing unit. Alternatively, the processor 9002 can be any other type of device, or multiple devices, capable of manipulating or processing information now-existing or hereafter developed. Although the disclosed implementations can be practiced with a single processor as shown, e.g., the processor 9002, advantages in speed and efficiency can be achieved using more than one processor.

A memory 9004 in the apparatus 9000 can be a read only memory (ROM) device or a random access memory (RAM) device in an implementation. Any other suitable type of storage device can be used as the memory 9004. The memory 9004 can include code and data 9006 that is accessed by the processor 9002 using a bus 9012. The memory 9004 can further include an operating system 9008 and application programs 9010, the application programs 9010 including at least one program that permits the processor 9002 to perform the methods described here. For example, the application programs 9010 can include applications 1 through N, which further include a video coding application that performs the methods described herein.

The apparatus 9000 can also include one or more output devices, such as a display 9018. The display 9018 may be, in one example, a touch sensitive display that combines a display with a touch sensitive element that is operable to sense touch inputs. The display 9018 can be coupled to the processor 9002 via the bus 9012.

Although depicted here as a single bus, the bus 9012 of the apparatus 9000 can be composed of multiple buses. Further, a secondary storage can be directly coupled to the other components of the apparatus 9000 or can be accessed via a network and can comprise a single integrated unit such as a memory card or multiple units such as multiple memory cards. The apparatus 9000 can thus be implemented in a wide variety of configurations.

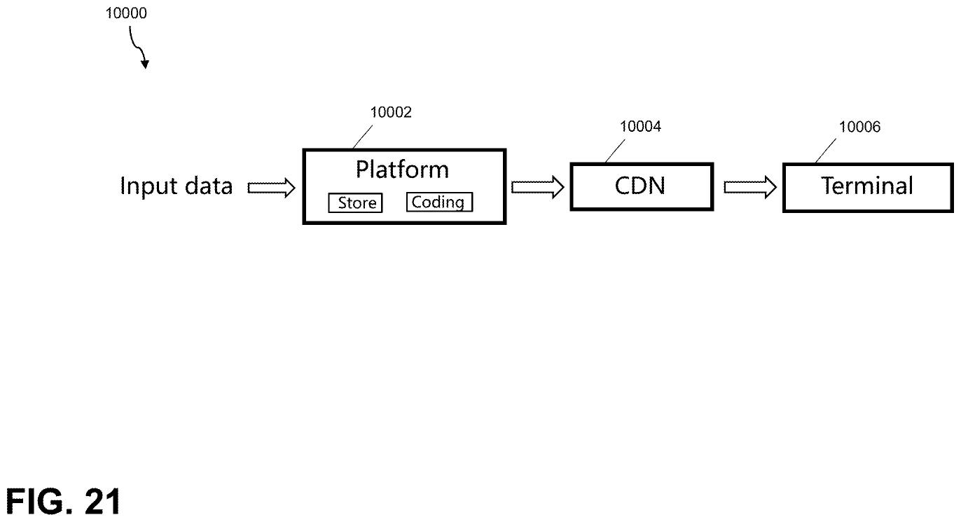

FIG. 21 is a block diagram of a video coding system 10000 according to an embodiment of the present disclosure.

A platform 10002 in the system 10000 can be a cloud sever or local sever. Alternatively, the platform 10002 can be any other type of device, or multiple devices, capable of calculation, storing, transcoding, encryption, rendering, decoding or encoding. Although the disclosed implementations can be practiced with a single platform as shown, e.g., the platform 10002, advantages in speed and efficiency can be achieved using more than one platform.

A content delivery network (CDN) 10004 in the system 10000 can be a group of geographically distributed servers. Alternatively, the CDN 10004 can be any other type of device, or multiple devices, capable of data buffering, scheduling, dissemination or speed up the delivery of web content by bringing it closer to where users are. Although the disclosed implementations can be practiced with a single CDN as shown, e.g., the CDN 10004, advantages in speed and efficiency can be achieved using more than one CDN.

A terminal 10006 in the apparatus 10000 can be a mobile phone, computer, television, laptop, camera. Alternatively, the terminal 10006 can be any other type of device, or multiple devices, capable of displaying video or image.

What is claimed is:

1. A video compression device having one or more processors configured to execute video compression by:
receiving video data representing a video stream;
for each of a plurality of regions in a state of the video stream, estimating motion between that region in that state and corresponding regions in other states of the video stream;
selecting one or more parts in the state of the video stream as a part to be skipped in dependence on the respective estimated motion for an associated region in the state of the video stream; and
encoding the video data to form a residual representing the state of the video stream in one or more channels by, in response to a part having been selected to be skipped, omitting data representing that part in at least one of the channels from the residual.

2. The video compression device in claim 1, wherein the one or more processors are configured to, for each part in the state of the video stream having an associated region in the state of the video stream, determine a motion complexity measure based on the estimated motion for the associated region and select the one or more of the parts to be skipped in dependence on the respective motion complexity measure.

3. The video compression device in claim 2, wherein the motion complexity measure for the respective part is a local motion variance for the respective associated region.

4. The video compression device in claim 3, wherein the local motion variance is determined from a decoded displacement field for respective spatial positions of the state of the video stream.

5. The video compression device in claim 3, wherein the local motion variance is a channel-wise variance for the respective associated region.

6. The video compression device in claim 2, wherein the motion complexity measure for the respective part is a motion entropy for the respective associated region.

7. The video compression device in claim 2, wherein the motion complexity measure for the respective part is a channel-weighted motion variance for the respective associated region.

8. The video compression device in claim 2, wherein the motion complexity measure for the respective part is learned.

9. The video compression device in claim 2, wherein the one or more processors are configured to aggregate the motion complexity measure for the respective part over multiple channels.

10. The video compression device in claim 9, wherein the one or more processors are configured to sum the motion complexity measure for the respective part over multiple channels.

11. The video compression device in claim 2, wherein the one or more processors are configured to aggregate the motion complexity measure for the respective part over a spatial dimension.

12. The video compression device in claim 1, wherein the one or more processors are configured to classify each part into one of a plurality of classes based on the estimated motion for the respective associated region.

13. The video compression device in claim 12, wherein the one or more processors are configured to classify each part into one of the plurality of classes based on the motion complexity measure for the respective part.

14. The video compression device in claim 13, wherein the plurality of classes is defined by splitting the interval
$$[ {min}_{m , n} C [ m , n ] ; {max}_{m , n} C [ m , n ] ]$$
for a respective state into N sub-intervals and wherein the one or more processors are configured to assign each part a class according to the sub-interval in which the corresponding value of C[m, n] falls,
wherein C is the motion complexity measure, m, n is a spatial position in a latent representation of the state of the video stream and N is the number of classes.

15. The video compression device in claim 14, wherein the one or more processors are configured to split the interval
$$[ {min}_{m , n} C [ m , n ] ; {max}_{m , n} C [ m , n ] ]$$
for a respective state into N non-overlapping sub-intervals of equal size, or wherein the one or more processors are configured to split the interval
$$[ {min}_{m , n} C [ m , n ] ; {max}_{m , n} C [ m , n ] ]$$
for a respective state into N sub-intervals of unequal size.

16. The video compression device in claim 13, wherein the one or more processors are configured to assign each part a class based on fixed or predetermined ranges of the motion complexity measure.

17. The video compression device in claim 12, wherein the one or more processors are configured to select one or more of the parts as a part to be skipped in each class separately.

18. The video compression device in claim 12, wherein the one or more processors are configured to signal for each of the classes skip information to indicate which regions are selected to be skipped,
wherein the one or more processors are configured to signal the channels to be skipped for each class.

19. The video compression device in claim 12, wherein the one or more processors are configured to skip one or more parts in a respective class in dependence on a threshold for that class and the respective motion complexity measure(s) for the respective one or more parts.

20. The video compression device in claim 1, wherein each of the plurality of regions in a state of the video stream comprises an associated part of the state of the video stream and multiple neighbouring parts of the state of the video stream.

21. A video compression method comprising:
receiving video data representing a video stream;
for each of a plurality of regions in a state of the video stream, estimating motion between that region in that state and corresponding regions in other states of the video stream;
selecting one or more parts of the state of the video stream as a part to be skipped in dependence on the respective estimated motion for an associated region of the state of the video stream; and
encoding the video data to form a residual representing the state of the video stream in one or more channels by, in response to a part having been selected to be skipped, omitting data representing that part in at least one of the channels from the residual.

22. A bitstream representing a state of a video stream, wherein the bitstream comprising blocks of data, wherein each block of data is decodable to reconstruct a representation of a respective first part of the state of the video stream, wherein the bitstream comprising skip data indicating an absence from the bitstream of such a block of data for one or more second parts of the state of the video stream, and wherein the one or more first parts are associated with regions of the state of the video stream having the greatest motion relative to corresponding regions in other states of the video stream.

23. The bitstream as claimed in claim 22, wherein each first part and each second part in the state of the video stream has an associated region in the state of the video stream,
wherein motion of a region relative to corresponding regions in other states of the video stream is indicated by a motion complexity measure.

24. A video decompression device having one or more processors configured to execute video compression by:
receiving encoded data for one or more first parts of a state of a video stream and skip data indicating an absence of encoded data for one or more second parts of the state of the video stream;
decoding the received encoded data to reconstruct a representation of the state of the video stream in one or more channels for the one or more first parts of the state of the video stream,
wherein the one or more first parts are associated with respective regions of the state of the video stream having the greatest motion relative to corresponding regions in other states of the video stream; and
reconstructing a representation of the state of the video stream in one or more channels for the one or more second parts of the video stream.

25. The video decompression device as claimed in claim 24, wherein each first part and each second part in the state of the video stream has an associated region in the state of the video stream,
wherein motion of a region relative to corresponding regions in other states of the video stream is indicated by a motion complexity measure.

26. A video decompression method comprising:
receiving encoded data for one or more first parts of a state of a video stream and skip data indicating an absence of encoded data for one or more second parts of the state of the video stream;
decoding the received encoded data to reconstruct a representation of the state of the video stream in one or more channels for the one or more first parts of the state of the video stream,
wherein the one or more first parts are associated with respective regions of the state of the video stream having the greatest motion relative to corresponding regions in other states of the video stream; and
reconstructing a representation of the state of the video stream in one or more channels for the one or more second parts of the video stream.
